(19) United States
(12) Patent Application Publication
(10) Pub. No.: US 2012/0196977 A1
(43) Pub. Date: Aug. 2, 2012

(54) URETHANE RESIN COMPOSITION, CURED OBJECT, AND PHOTOSEMICONDUCTOR DEVICE USING CURED OBJECT

(75) Inventors: Takeo Tomiyama, Tsukuba-shi (IT); Kenji Suzuki, Tsukuba-shi (JP); Makoto Mizutani, Tsukuba-shi (JP); Shouko Tanaka, Shinjuku-ku (JP); Akihiro Yoshida, Tsukuba-shi (JP); Shingo Kobayashi, Ichihara-shi (JP); Hayato Kotani, Tsukuba-shi (JP); Norihiro Fukuta, Tokushima-shi (JP); Isao Tada, Tokushima-shi (JP)

(73) Assignee: Hitachi Chemical Company, Ltd., Tokyo (JP)

(21) Appl. No.: 13/500,428

(22) PCT Filed: Apr. 13, 2010
(86) PCT No.: PCT/JP2010/056608

§ 371 Date: Apr. 5, 2012

(30) Foreign Application Priority Data
Oct. 5, 2009 (JP) 2009-231560
Oct. 5, 2009 (JP) 2009-231561
Mar. 1, 2010 (JP) 2010-044565
Mar. 1, 2010 (JP) 2010-044567

(51) Int. Cl. C08L 75/04; C08G 18/75; C08L 83/10; C08G 18/73

(52) U.S. Cl. 524/590; 528/85; 524/871; 528/28; 525/415

(57) ABSTRACT

A urethane resin composition obtained by a method comprising the steps of:
melt mixing an isocyanate (B), an antioxidant (C), a release agent (D) and a dispersing agent (E) to obtain a molten mixture, and
mixing the molten mixture and a polyol (A):
wherein the release agent (D) is a compound represented by the following formula (1):

[Chemical Formula 1]

R¹—COOH (1)
the dispersing agent (E) is a compound represented by the following formula (2) having a weight-average molecular weight Mw of no greater than 16000:

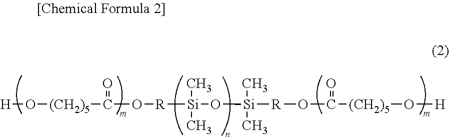

and the content of the dispersing agent (E) in the urethane resin composition is 0.1 to 5.0 wt %.

### TECHNICAL FIELD

The present invention relates to a urethane resin composition, a cured object, and a photosemiconductor device using the cured object.

### BACKGROUND ART

Urethane resins have excellent mechanical properties including toughness and strength, and are therefore widely used in industrial fields and daily life product fields. Among them, urethane resins that employ aliphatic isocyanates or alicyclic isocyanates have high transparency in the near ultraviolet region, and excellent coloration resistance, and they are therefore used for coating purposes in which weather resistance is required, and for optical purposes.

Methods that are known for molding cured urethane resins include casting methods in which an isocyanate-containing solution and a polyol-containing solution are mixed, cast into a die and thermoset, and then removed from the die after cooling, and reaction/injection/molding methods in which a mixed solution is cast into a heated die under pressure, and removed from the die after curing has been accomplished in a brief period under pressure and heat; however, there is a demand for faster curing in shorter time periods.

Nevertheless, the conventional basic catalysts or metal salt-based catalysts commonly used as catalysts for urethanation reaction are known to have adverse effects on the tint of cured products, and they are undesirable for optical purposes. When a basic catalyst or metal salt-based catalyst is used, an adverse effect is exhibited on the stability during storage, or “pot life”.

In addition, aliphatic isocyanates and alicyclic isocyanates have inferior reactivity with polyols compared to aromatic isocyanates, due to both electron factors and spatial structural factors. Therefore, basic catalysts such as amines are used as accelerators for urethanation reaction between isocyanate groups and hydroxyl groups. This is attributed to coordination of amines with the carbon atoms of isocyanate groups, resulting in increased electrophilicity of the central carbon atoms and accelerated reaction with the hydroxyl groups.

Acids also act as accelerators for urethanation reaction in the same manner. This is attributed to addition of protons to the oxygen atoms of isocyanate groups, similarly resulting in increased electrophilicity of the central carbon atoms and accelerated reaction with the hydroxyl groups. The reaction-accelerating effect is not limited to Bronsted acids, and metal salt-based catalysts classified as Lewis acids are generally considered to have higher activity than amine-based catalysts.

Given these circumstances, for the reaction/injection/molding methods mentioned above which require fast-curing properties, the following have been proposed as reaction accelerators: organic tin catalysts in Patent document 1, combinations of metal salts of carboxylic acids or amidecarboxylic acids with tertiary amine compounds in Patent document 2, combinations of metal carboxylates, metal halides or ammonium carboxylates, tin-sulfur catalysts and tertiary amines in Patent document 3, and combinations of bismuth organic acid salts and calcium organic acid salts in Patent document 4.

As internal release agents to be used in urethane resins, there are used synthetic compounds including higher fatty acids, fatty acid esters and higher alcohols, depending on the purpose.

In order for the release agent to exhibit an adequate releasing effect, it is important for the release agent to be deposited on the surface of the cured resin and to act on the interface with the die. If a release agent with low compatibility with the resin is added during curing, the release agent will be deposited more easily at the interface between the cured resin and the die. However, the components that have not been deposited on the surface of the cured resin are present in particulate form in the cured resin, and this results in opacity of the cured resin, and thus reduced transparency.

In order to solve this problem, there is demand for a resin composition wherein the release agent component uniformly disperses in the resin and is deposited on the surface of the cured product.

Patent Document 5, for example, discloses a method of using a specific saturated fatty acid as the release agent for uniform dispersion of the releasability-imparting components into the resin composition.

Also, Patent document 6 discloses a method of using a compound with multiple ether bonds as a release agent, in order to obtain both transparency and releasability.

In photosemiconductor devices there are used sealing members which cure resin compositions and protect photosemiconductor elements. Curing of a resin composition is usually accomplished by filling the resin composition into a cavity formed by a molding die in a molding apparatus, and heating the molding die. In such cases, a release agent is sometimes added to the resin composition to prevent excessive bonding between the cured resin composition and the molding die. This can yield a cured object with excellent releasability with the molding die. Patent document 5 discloses the use of a saturated fatty acid, and Patent document 7 discloses the use of a compound with multiple ether bonds, as release agents.

However, as a sealing member for a photosemiconductor device, a cured object must have adhesiveness with peripheral parts. A lead frame, which is a type of part in semiconductor devices, generally has a silver plating on the surface, and during molding, reflow mounting or temperature cycling testing, detachment often occurs at the interface between the sealing member and the silver plating surface.

Also, epoxy resins, silicone resins, urethane resins and the like are used in sealing members from the viewpoint of optical transparency and mechanical strength, but while such resins are generally considered to have excellent adhesiveness with materials, they tend to have poor adhesiveness for silver or gold compared to other metals.

In photosemiconductor devices, sealing members are molded by curing a resin composition for protection of photosemiconductor elements. The curing and molding of the resin composition is usually accomplished by a potting method with casting in a case or a lead frame cavity, a liquid transfer molding method in which a resin composition is filled into a cavity formed by a molding die in a molding apparatus, or a compression molding method. In such cases, a hard transparent resin is required for structures in which the shape of the photosemiconductor device is formed only by a transparent resin and a lead frame, or structures in which a lens shape is formed by a transparent resin.

In addition, a high glass transition temperature is preferred for the cured object, in order to ensure mounting reliability. The crosslink density is generally set higher in order to obtain a hard cured object with a high glass transition temperature. In order to obtain a high crosslink density for urethane resin systems as well, it is effective to include a short-chain-length polyfunctional polyol compound in the polyol component, and Non-patent document 1 describes an example where trimethylolpropane or glycerin is added to a polyol component.

In recent years, resin compositions for photosemiconductor element sealing, which are used to seal photosemiconductor elements such as light emitting elements and photodetecting sensors, are required to have transparency when cured. Also, releasability to allow easy release from dies is required for transfer molding and cast molding.

Methods have been proposed to improve the transparency and releasability of resin compositions for photosemiconductor element sealing, including a method in which higher fatty acids or fatty acid esters are added to promote uniform dispersion of the releasability-imparting components in resin compositions (in Patent document 5, for example). A method for improving releasability by addition of a silicone compound has also been proposed (in Patent document 8, for example).

### CITATION LIST

### Patent Literature

[Patent document 1] Japanese Patent Publication No. 3911030
[Patent document 2] Japanese Patent Publication No. 2703180
[Patent document 3] Japanese Patent Publication No. 3605160
[Patent document 4] Japanese Unexamined Patent Application Publication No. 2007-246829
[Patent document 5] Japanese Unexamined Patent Application Publication No. 2001-234033
[Patent document 6] Japanese Patent Publication No. 2781279
[Patent Document 7] International Patent Publication No. WO96/15191
[Patent Document 8] International Patent Publication No. WO2006/011385

### Non-Patent Literature

[Non-patent document 1] Journal of Wuhan University of Technology Mater. Sci. Ed Vol. 20, No. 2. June 2005, 24-28

### SUMMARY OF INVENTION

### Technical Problem

However, the resin compositions described in Patent documents 1-4, while exhibiting excellent curing-promoting effects, have short pot lives, and adverse effects are also seen on transparency and coloration of the cured resins.

Furthermore, in methods such as described in Patent document 5, it is necessary to add a large amount of release agent for uniform dispersion of the release agent while maintaining suitable releasability, and the resulting reduction in curability has been a major problem.

Also, in methods such as described in Patent document 6, it is extremely difficult to adjust the proportions of the components involved in releasability and the components involved in compatibility, and the releasability is also lower than common release agents.

When a release agent is added to a resin composition for production of a semiconductor device, it is possible to improve the releasability from the molding die, but the adhesiveness with the lead frame and other sections can potentially be reduced. According to research by the present inventors, detachment has been found between lead frames and sealing members in some mass-produced photosemiconductor devices with addition of release agents to resin compositions. Thus, sealing members or cured objects have not always maintained a high level of both releasability with molding dies and adhesiveness with peripheral members of photosemiconductor devices.

Moreover, polyols such as trimethylolpropane and glycerin have high polarity and therefore inferior compatibility with isocyanate components, while also having high steric hindrance and therefore inferior reactivity with isocyanate components. Particularly when such polyols are used in combination with other polyol compounds, differences in reactivity make it difficult to obtain uniform cured objects, as fluctuations are seen in the cured objects.

For urethane resins as well, the use of short-chain-length polyfunctional polyols is known for obtaining high crosslink density. However, introduction of large amounts makes it difficult to obtain uniform cured objects due to differences in reactivity with other polyol compounds, and problems such as air bubbles are observed, presumably due to uncured components.

Thus, while increasing the introduction of short-chain-length polyfunctional polyols can yield hard cured objects with high glass transition temperatures, the homogeneity of the cured objects tends to be inferior, and high levels of both properties have not always been maintained.

In addition, large amounts of higher fatty acids and fatty acid esters must be added when it is attempted to use higher fatty acids and fatty acid esters to uniformly disperse release agents while maintaining suitable releasability, and this has led to the major problem of reduced curability. Resin compositions with reduced release agent contents have been proposed as means of solving this problem, but such methods create the new problem of inferior continuous moldability, due to a lack of releasability.

In addition, in methods where a silicone compound is added to improve releasability, the problem of notably reduced transparency has been encountered.

It is therefore an object of the present invention to provide a urethane resin composition with an excellent curing acceleration effect, a sufficiently long pot life and high transparency as a cured product, as well as its cured resin product.

It is another object of the invention to provide the urethane resin composition having excellent transparency and releasability and a photosemiconductor device employing its cured product.

It is yet another object of the invention to provide a cured object with excellent adhesiveness with silver platings, a photosemiconductor device employing it, and a urethane resin composition from which they can obtained.

It is yet another object of the invention to provide a urethane resin composition that can yield a hard cured object with a high glass transition temperature, and excellent homogeneity.

It is yet another object of the invention to provide a urethane resin composition that has excellent transparency and adhesion with lead frames, and excellent releasability during transfer molding, as well as its cured product.

### Solution to Problem

The present invention provides a urethane resin composition comprising an aliphatic or alicyclic polyisocyanate, a saturated polyol and zinc stearate with a bulk density of no greater than 0.12 g/ml.

Using such a urethane resin composition, the curing acceleration effect is excellent, the pot life is sufficiently long, and the transparency of the cured product is high.

The alicyclic polyisocyanate is preferably a bifunctional or trifunctional alicyclic polyisocyanate having an isocyanate group bonded to a secondary carbon atom.

The urethane resin composition preferably has a gelling time of no longer than 40 seconds at 165° C., and the transmittance of its 1 mm-thick cured object at 589 nm is preferably 90% or greater.

The invention further provides a cured object being a cured product of the urethane resin composition of the invention. Such a cured object as high transparency because a urethane resin composition of the invention is used.

The invention further provides a urethane resin composition obtainable by a method comprising the steps of:

melt mixing an isocyanate (B), an antioxidant (C), a release agent (D) and a dispersing agent (E) to obtain a molten mixture; and

mixing the molten mixture and a polyol (A),

wherein the release agent (D) is a compound represented by the following formula (1):

[Chemical Formula 1]

R¹—COOH (1)

wherein R¹ is a straight-chain or branched C7-28 hydrocarbon group,

the dispersing agent (E) is a compound represented by the following formula (2) having a weight-average molecular weight Mw of no greater than 16000:

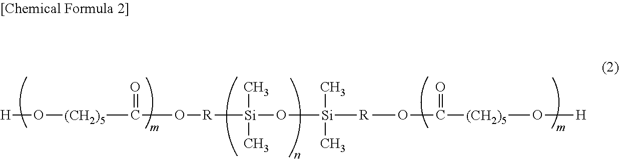

wherein R is a divalent hydrocarbon group, m and n are positive integers, and the ratio of m/n is 0.6 to 0.8, and

the content of the dispersing agent (E) in the urethane resin composition is 0.1 to 5.0 wt %.

Such a urethane resin composition has excellent transparency and releasability. While the reason for which such an effect is obtained by the urethane resin composition of the invention is not fully understood, the present inventors conjecture that the pre-melt mixing of components (B)-(E) with high compatibility is one factor. The effect cannot be obtained when components (A) and (C)-(E) are subjected to pre-melt mixing instead of components (B)-(E).

The content of the release agent (D) in the urethane resin composition is preferably 0.1 to 5.0 wt %.

The invention further provides a photosemiconductor device comprising a sealing member obtained by curing the urethane resin composition of the invention. Such a photosemiconductor device has high transparency because a urethane resin composition of the invention is used.

According to the invention, there is provided a two-pack type urethane resin composition comprising a solution A containing a polyol component and a solution B containing a polyisocyanate component, the two-pack type urethane resin composition including a silane coupling agent with a thiol group in solution A or solution B.

The cured object obtained from such a two-pack type urethane resin composition has high adhesiveness with silver platings.

While the reason for which high adhesiveness is obtained between the cured object and silver platings with the urethane resin composition of the invention is not fully understood, the present inventors conjecture as follows.

In general, thiol groups are thought to form coordinated bonds or covalent bonds with metals of Group 1B such as gold, silver and copper. The present inventors also believe that in the urethane resin composition of the invention, the thiol groups or hydrolyzed silanol groups of the thiol group-containing silane coupling agent react with isocyanate groups in the polyisocyanate component to form thiourethane bonds. Presumably, formation of such bonds between the cured object and silver allows an effect of improved adhesiveness to be obtained.

Preferably, the polyisocyanate component includes a bifunctional or trifunctional polyisocyanate of which at least one of the isocyanate groups bonds to a secondary carbon, the polyisocyanate having an alicyclic structure, and an isocyanate group-remaining prepolymer, at a total of 30 wt % or greater.

By including prescribed amounts of a polyisocyanate having such a structure and an isocyanate group-remaining prepolymer, it is possible to increase the glass transition temperature of the obtained cured object.

The silane coupling agent with a thiol group is preferably γ-mercaptopropyltrimethoxysi lane or γ-mercaptopropylmethyldimethoxysilane.

The silane coupling agent with a thiol group is also preferably present at 0.1 to 2.0 wt % with respect to the total of the polyol component and polyisocyanate component.

By including the silane coupling agent with a thiol group in this range, it is possible to satisfactorily improve the balance between adhesiveness with silver platings and heat resistance of the obtained cured object.

Also, solution B preferably contains a fatty acid represented by the following formula (1), and a silicone-caprolactone block copolymer represented by the following formula (3) and having a weight-average molecular weight of no greater than 16000.

[Chemical Formula 3]

R¹—COOH (1)

wherein in the formula, R¹ represents a C7-28 straight-chain or branched hydrocarbon group,

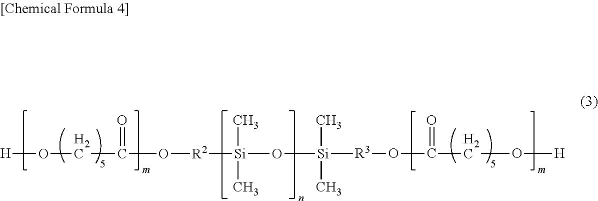

wherein in the formula, m and n are positive integers such that the ratio of m/n is 0.5 to 1.0, R² and R³ each independently represent a divalent hydrocarbon group or a polyether chain.

The fatty acid and silicone-caprolactone block copolymer both function as dispersing agents and release agents. If solution B further contains these compounds, it will be possible to improve the releasability with the molding die when the urethane resin composition is molded to obtain a cured object, without impairing adhesiveness with silver platings.

According to the invention there is provided a cured object obtainable by curing a urethane resin composition comprising a polyol component, a polyisocyanate component and a silane coupling agent with a thiol group.

The cured object obtained in this manner has high adhesiveness with silver platings.

Also, the urethane resin composition preferably further contains a fatty acid represented by formula (1) above, and a silicone-caprolactone block copolymer represented by formula (3) above and having a weight-average molecular weight of no greater than 16000.

The urethane resin composition preferably further comprises an inorganic filler.

If it further comprises an inorganic filler, the thermal expansion coefficient of the cured object will approach the thermal expansion coefficient of a lead frame, thus helping to prevent detachment from lead frames in heat resistance testing and temperature cycling testing.

According to the invention there is further provided a photosemiconductor device comprising a sealing member composed of the aforementioned cured object.

Such a photosemiconductor device has high optical transparency of the cured object and excellent optical characteristics such as light-coloring resistance, and mechanical properties.

According to the invention, there is also provided a two-pack type urethane resin composition comprising a solution A containing a polyol component and a solution B containing a polyisocyanate component, the two-pack type urethane resin composition including a compound with 2 or more thiol groups in solution A or solution B.

The cured object obtained from such a two-pack type urethane resin composition has high adhesiveness with silver platings.

While the reason for which high adhesiveness is obtained between the cured object and silver platings with the urethane resin composition of the invention is not fully understood, the present inventors conjecture as follows.

In general, thiol groups or sulfide groups are thought to form coordinated bonds or covalent bonds with metals of Group 1B such as gold, silver and copper. The present inventors also believe that in the urethane resin composition of the invention, the thiol groups of the compound with 2 or more thiol groups react with isocyanate groups in the polyisocyanate component to form thiourethane bonds. Presumably, formation of such bonds between the cured object and silver allows an effect of improved adhesiveness to be obtained.

Preferably, the polyisocyanate component includes a bifunctional or trifunctional polyisocyanate of which at least one of the isocyanate groups bonds to a secondary carbon, the polyisocyanate having an alicyclic structure, and an isocyanate group-remaining prepolymer, at a total of 30 wt % or greater.

By including prescribed amounts of a polyisocyanate having such a structure and an isocyanate group-remaining prepolymer, it is possible to increase the glass transition temperature of the obtained cured object.

In addition, the compound with 2 or more thiol groups preferably further has a sulfide group.

If the compound with 2 or more thiol groups has a sulfide group, it will possible to further improve adhesiveness between the obtained cured object and silver platings.

The compound with 2 or more thiol groups is preferably 2,2′-dimercaptodiethyl sulfide.

The compound with 2 or more thiol groups is also preferably present at 0.01 to 2.0 wt % with respect to the total of the polyol component and polyisocyanate component.

By including the compound with 2 or more thiol groups in this range, it is possible to satisfactorily improve the balance between adhesiveness with silver platings and heat resistance of the obtained cured object.

Also, solution A or solution B preferably contains a saturated fatty acid represented by the following formula (1), and a silicone-caprolactone block copolymer represented by the following formula (3) and having a weight-average molecular weight of no greater than 16000.

[Chemical Formula 5]

R¹—COOH (1)

wherein in the formula, R¹ represents a C7-28 straight-chain or branched saturated hydrocarbon group,

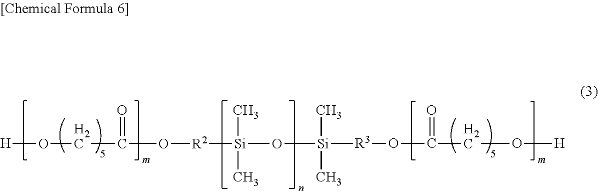

wherein in the formula, m and n are positive integers such that the ratio of m/n is 0.5 to 1.0, R² and R³ each independently represent a divalent hydrocarbon or a polyether chain.

The saturated fatty acid and silicone-caprolactone block copolymer both function as dispersing agents and release agents. If solution A or solution B further contains these compounds, it will be possible to improve the releasability with the molding die when the urethane resin composition is molded to obtain a cured object, without impairing adhesiveness with silver platings.

According to the invention there is also provided a cured object obtainable by curing a urethane resin composition comprising a polyol component, a polyisocyanate component and a compound with 2 or more thiol groups.

The cured object obtained in this manner has high adhesiveness with silver platings.

Also, the urethane resin composition preferably further contains a saturated fatty acid represented by formula (1) above, and a silicone-caprolactone block copolymer represented by formula (3) above and having a weight-average molecular weight of no greater than 16000.

The urethane resin composition preferably further comprises an inorganic filler.

If it further comprises an inorganic filler, the thermal expansion coefficient of the cured object will approach the thermal expansion coefficient of a lead frame, thus helping to prevent detachment from lead frames in heat resistance testing and temperature cycling testing.

According to the invention there is further provided a photosemiconductor device comprising a sealing member composed of the aforementioned cured object.

Such a photosemiconductor device has high optical transparency of the cured object and excellent optical characteristics such as light-coloring resistance, and mechanical properties.

According to the invention, the urethane resin composition comprising solution A containing a polyol component and solution B containing a polyisocyanate component wherein solution A includes a trifunctional or greater polyol compound having a hydroxyl value of 600 mgKOH/g or more and 1300 mgKOH/g or less, and having a molecular weight of no greater than 400. A cured object obtained from such a urethane resin composition is hard, has a high glass transition temperature, and also has excellent homogeneity.

The reason for which cured objects are hard with both a high glass transition temperature and homogeneity when using the urethane resin composition of the invention is not completely understood, but the present inventors conjecture as follows. That is, it is believed that if preferably at least 80 wt % of the polyol component is composed of a polyol compound set to have a hydroxyl value of 600 mgKOH/g or more and 1300 mgKOH/g or less and having a molecular weight of no greater than 400, a more homogeneous cured object can be obtained with a low difference in reactivities between different polyols, while maintaining hardness and glass transition temperature, than when the polyol component is composed of several different polyols with different reactivities.

The polyisocyanate component comprises at least 30 wt % of an alicyclic polyisocyanate compound having an alicyclic group and 2 or 3 isocyanate groups, with at least one of the isocyanate groups bonded to a secondary carbon composing the alicyclic group. By including a polyisocyanate wherein the polyisocyanate component has such a structure, it is possible to further increase the glass transition temperature of the obtained cured object.

Also, the polyol compound is preferably a compound in which propylene oxide, ethylene oxide or caprolactone is added to trimethylolpropane or propane-1,2,3-triol.

The polyol compound is also preferably a compound in which propylene oxide is added at 1-2 mol to 1 mol of trimethylolpropane.

The content of the polyol compound is preferably 80 wt % or greater with respect to the total polyol component. A content within this range can increase the hardness and glass transition temperature of the cured object, while simultaneously obtaining a homogeneous cured object in a satisfactory balance.

Also, preferably solution A or solution B contains a saturated fatty acid represented by the following formula (1), or such a saturated fatty acid and a silicone-caprolactone block copolymer represented by the following formula (3) and having a weight-average molecular weight of no greater than 16000.

[Chemical Formula 7]

R¹—COOH (1)

In the formula, R¹ represents a C7-28 straight-chain or branched hydrocarbon group.

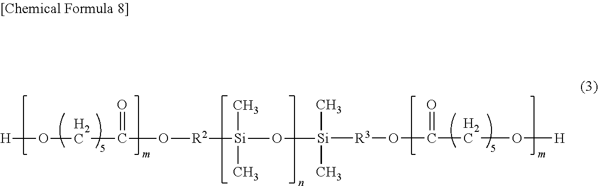

In the formula, m and n are positive integers such that m/n is 0.5 to 1.0, R² and R³ each independently represent a divalent hydrocarbon group or a polyether chain.

The saturated fatty acid and silicone-caprolactone block copolymer both function as dispersing agents and release agents. If solution A or solution B further contains these compounds, it will be possible to improve the releasability with the molding die when the urethane resin composition is molded to obtain a cured object, without impairing adhesiveness with silver platings.

Solution A or solution B also preferably further contains an inorganic filler. If it further comprises an inorganic filler, the thermal expansion coefficient of the cured object will approach the thermal expansion coefficient of a lead frame, thus helping to prevent detachment from lead frames in heat resistance testing and temperature cycling testing.

In addition, solution A or solution B preferably further contains an adhesion-imparting agent for silver plating or palladium plating. By increasing adhesion with silver platings or palladium platings, it is possible to help prevent detachment with lead frames in heat resistance testing or temperature cycling testing.

The invention still further provides a photosemiconductor device comprising a sealing member composed of a cured object of the aforementioned urethane resin composition. Such a photosemiconductor device has high optical transparency and homogeneity of the cured object and excellent optical characteristics such as light-coloring resistance, and mechanical properties.

According to the invention there is further provided a urethane resin composition comprising (A) a polyol component and (B) a polyisocyanate component, wherein the polyisocyanate component is an isocyanate component comprising an alicyclic polyisocyanate compound having an alicyclic group and 2 or 3 isocyanate groups, at least one of the isocyanate groups being bonded to a secondary carbon composing the alicyclic group, at 30 wt % or greater of the total isocyanate component, and the urethane resin composition further comprises a polyether-modified silicone-caprolactone block copolymer represented by the following formula (4), and (C) a saturated fatty acid represented by the following formula (1). Using a urethane resin composition having such a composition exhibits effects of excellent transparency and adhesion with lead frames, and excellent releasability during transfer molding.

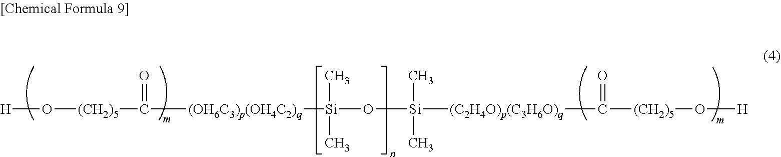

In formula (4), m and n represent positive integers such that m/n is 0.5 to 1.0. Also, p and q are positive integers such as p and q>1, and p or q 2.

[Chemical Formula 10]

R¹—COOH (1)

In formula (1), R¹ represents a C7-28 straight-chain or branched hydrocarbon group.

The urethane resin composition preferably further comprises (D) a compound with a thiol group. By further comprising a compound with a thiol group, an effect of more excellent adhesion with lead frames is exhibited.

Also, the compound with a thiol group is preferably a compound with 2 or more thiol groups, or a silane coupling agent with a thiol group.

The invention still further provides a photosemiconductor device comprising a sealing member composed of a cured object obtained by curing the aforementioned urethane resin composition.

### Advantageous Effects of Invention

According to the invention, it is possible to provide a urethane resin composition with an excellent curing acceleration effect, a sufficiently long pot life and high transparency as a cured product, as well as its cured resin product. Since the urethane resin composition of the invention has high transparency when cured, it is suitable as a material for molded articles for optical purposes, and since its pot life is sufficiently long, it can be suitably molded by molding methods such as casting methods and reaction/injection/molding methods.

According to the invention it is also possible to provide the urethane resin composition having excellent transparency and releasability and a photosemiconductor device employing its cured product.

According to the invention it is also possible to provide a cured object with excellent adhesiveness with silver platings and palladium platings, a photosemiconductor device, and a urethane resin composition from which they can obtained.

According to the invention it is also possible to provide a urethane resin composition that can yield a hard cured object with a high glass transition temperature, and excellent homogeneity.

According to the invention it is also possible to provide a urethane resin composition that has excellent transparency and adhesion with lead frames, and excellent releasability during transfer molding, as well as its cured product.

### BRIEF DESCRIPTION OF DRAWINGS

FIG. 1 is a schematic cross-sectional view of a surface mounted LED package, as a preferred example of a photosemiconductor device according to the invention.

FIG. 2 is a cross-sectional view showing an embodiment of a photosemiconductor device according to the invention.

FIG. 3 is a diagram schematically illustrating measurement of the shear bonding strength of a cured object.

### DESCRIPTION OF EMBODIMENTS

Preferred embodiments of the invention will now be described in detail. However, the present invention is not limited to the embodiments described below.

The urethane resin composition of the invention (hereunder also referred to simply as “resin composition”) comprises an aliphatic or alicyclic polyisocyanate, a saturated polyol, and zinc stearate with a bulk density of no greater than 0.12 g/ml.

The urethane resin composition of the invention is obtainable by a method comprising the steps of melt mixing an isocyanate (B), an antioxidant (C), a release agent (D) and a dispersing agent (E) to obtain a molten mixture, and mixing the molten mixture and a polyol (A).

The urethane resin composition of the invention is a two-pack type urethane resin composition comprising a solution A containing a polyol component and a solution B containing a polyisocyanate component, and including a silane coupling agent with a thiol group in solution A or solution B.

The urethane resin composition of the invention is also a two-pack type urethane resin composition comprising a solution A containing a polyol component and a solution B containing a polyisocyanate component, and including a compound with 2 or more thiol groups in solution A or solution B.

The urethane resin composition of this embodiment is a urethane resin composition comprising solution A containing a polyol component and solution B containing a polyisocyanate component, wherein solution A includes a trifunctional or greater polyol compound having a hydroxyl value of 600 mgKOH/g or more and 1300 mgKOH/g or less, and having a molecular weight of no greater than 400.

The urethane resin composition of this embodiment is also a urethane resin composition comprising (A) a polyol component and (B) a polyisocyanate component, wherein the polyisocyanate component is an isocyanate component comprising an alicyclic polyisocyanate compound having an alicyclic group and 2 or 3 isocyanate groups, at least one of the isocyanate groups being bonded to a secondary carbon composing the alicyclic group, at 30 wt % or greater of the total isocyanate component, and the urethane resin composition further comprises a polyether-modified silicone-caprolactone block copolymer represented by the following formula (4). In formula (4), m, n, p and q represent positive integers.

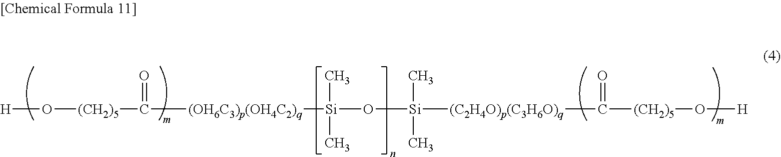

(Polyol Component)

The (A) polyol component of this embodiment is a component comprising a compound with 2 or more alcoholic hydroxyl groups (polyol). The polyol is preferably a saturated polyol. Specific examples include aliphatic polyols, alicyclic polyols, polyether polyols, polycarbonate polyols, polyester polyols, polycaprolactone polyols, acrylic resin polyols, and polyols with multiple oxygen atoms. Among these, the polyol is preferably a polyol with an aliphatic hydrocarbon group structure (aliphatic polyol), and more preferably an aliphatic polyol with 3 or more hydroxyl groups (polyfunctional aliphatic polyol). A polyol with many functional groups is particularly preferred since it will improve the crosslink density of the obtained cured object (also referred to as cured resin or cured product).

Examples of aliphatic polyols include trimethylolpropane, propane-1,2,3-triol, 1,4-butanediol, 1,3-propanediol, glycerin and pentaerythritol, among which trifunctional or greater aliphatic polyols such as trimethylolpropane and propane-1,2,3-triol are preferred. Examples of polyols with multiple oxygen atoms include polycaprolactonediol, polycaprolactone triol, polycarbonatediol, polycarbonatetriol, polyester diol and polyether diol. Polyols with numerous functional groups are especially preferred for improved crosslink density. Any of these polyols may be used alone or in combinations of two or more.

The hydroxyl equivalents and molecular weight of the polyol are preferably designed as follows in order to obtain the desired cured products. Specifically, when a soft cured product is to be obtained, it is preferred to use a polyol with low hydroxyl equivalents and a high molecular weight. Such polyols include polyether diols, polycarbonate diols or polyester diols having high molecular weights with two hydroxyl groups. When a hard cured product is to be obtained, it is preferred to use a polyol with high hydroxyl equivalents and a low molecular weight. Such polyols include polyols with low molecular weight and having two hydroxyl groups, such as polycarbonate diols and polycaprolactone diols, polyols with low molecular weight and having 3 hydroxyl groups, such as polycaprolactone triols, trimethylolpropane, propane-1,2,3-triol, and derivatives obtained by adding ethylene oxide or propylene oxide to the foregoing, and polyols with low molecular weight and having 4 hydroxyl groups, such as diglycerin or its derivatives obtained by adding ethylene oxide or propylene oxide to diglycerin. Any of these may be used alone or in combinations of two or more.

A hydroxyl group-remaining prepolymer may also be included in the polyol component. By including a hydroxyl group-remaining prepolymer in the polyol component, it is possible to improve the compatibility between the polyol component and polyisocyanate component. The hydroxyl group-remaining prepolymer may be obtained by reacting the polyol and the polyisocyanate described hereunder (preferably a polyisocyanate with an alicyclic group as explained hereunder), with the hydroxyl groups of the polyol in excess of the isocyanate groups of the polyisocyanate. For the ratio X/Y, where X represents the hydroxyl equivalents of the polyol and Y represents the isocyanate group equivalents of the polyisocyanate, the hydroxyl group-remaining prepolymer is preferably obtained by mixing and reacting the polyol and polyisocyanate with an X/Y ratio of 3-20. If X/Y is a value of 3 or greater, it will be possible to inhibit increase in the molecular weight of the hydroxyl group-remaining prepolymer and to maintain a manageable viscosity. If X/Y is a value of no greater than 20, the effect of the prepolymer will tend to be obtained more prominently. Synthesis of the hydroxyl group-remaining prepolymer can be shortened by adding a catalyst, but room temperature (25° C.) or thermal reaction under non-catalytic conditions is preferred to avoid coloration of the polymer.

The polyol component of this embodiment includes a polyol compound with a hydroxyl value of 600 mgKOH/g or more and 1300 mgKOH/g or less and having a molecular weight of no greater than 400. The polyol compound is preferably a compound having propylene oxide, ethylene oxide or caprolactone added to trimethylolpropane or propane-1,2,3-triol, and more preferably a compound having 1-2 mol of propylene oxide added to 1 mol of trimethylolpropane. By selecting a polyol having such hydroxyl equivalents and molecular weight, it is possible to obtain a hard cured object with a high glass transition temperature. In particular, a derivative having 1-2 mol of propylene or ethylene oxide added to 1 mol of trimethylolpropane, which has solid properties, will be liquid, and furthermore, propylene oxide is preferably used because it will allow increase in the glass transition temperature of the cured object over ethylene oxide, due to steric hindrance of the methyl groups.

These may be used alone, but they are preferably used in combination with another polyol to adjust the crosslink density or viscosity. In this case, a polyol compound with a hydroxyl value of 600 mgKOH/g or more and 1300 mgKOH/g or less and having a molecular weight of no greater than 400 is preferably present at 80 wt % or greater with respect to the total polyol component. In such a range, a homogeneous cured object can be obtained even when several different types of polyols are used together, and it is possible to reduce problems such as air bubbles that are presumably caused by uncured components.

(Polyisocyanate)

The (B) polyisocyanate component of this embodiment is a component composed of a compound with 2 or more isocyanate groups (polyisocyanate). A polyisocyanate is preferably an aliphatic or alicyclic polyisocyanate, and more preferably it is an alicyclic polyisocyanate compound having an alicyclic group and 2 or 3 isocyanate groups, with at least one of the isocyanate groups bonded to a secondary carbon composing the alicyclic group. Specific examples include isophorone diisocyanate, 4,4′-methylenebis-(cyclohexyl isocyanate), 1,3-bis-(isocyanatomethyl)cyclohexane, or norbornane diisocyanate (2,5-(2,6)-bis-isocyanatomethyl[2,2,1]heptane), isopropylidenebis(4-cyclohexyl isocyanate), cyclohexyl diisocyanate, and the like.

Particularly preferred are 1,3-bis(isocyanatomethyl)cyclohexane, norbornane diisocyanate (2,5-(2,6)bis-isocyanatomethyl[2,2,1]heptane), isophorone diisocyanate trimers and 1,3-bis(isocyanatomethyl)cyclohexane trimers, and mixtures of several different alicyclic diisocyanates may also be used. An isocyanate with an alicyclic backbone is preferred since it will not undergo yellowing even under heating.

There may also be used an isocyanurate-type, biuret-type or adduct-type polyisocyanate obtained using a polyisocyanate as the starting material, with isocyanurate-type polyisocyanates obtained using hexamethylene diisocyanate or isophorone diisocyanate as starting materials being particularly preferred. By using such polyisocyanates it is possible to increase the glass transition temperature of the obtained cured product. The proportion of the polyisocyanate with an alicyclic group with respect to the total polyisocyanate component is more preferably 30 wt % or greater. This will allow the high-temperature and high-humidity resistance of the cured product to be further improved.

The polyisocyanate component preferably contains an isocyanate group-remaining prepolymer. By including an isocyanate group-remaining prepolymer in the polyisocyanate component, it is possible to improve the compatibility between the polyol component and polyisocyanate component. The isocyanate group-remaining prepolymer may be obtained by reacting the polyisocyanate (preferably a polyisocyanate with an alicyclic group as mentioned above, in which case the prepolymer will include an alicyclic polyisocyanate) and the polyol mentioned above, with the isocyanate groups of the polyisocyanate in excess of the hydroxyl groups of the polyol. The isocyanate group-remaining prepolymer is preferably obtained by mixing and reacting the polyol and polyisocyanate with the aforementioned X/Y ratio at 0.05-0.3. If X/Y is a value of 0.05 or greater, the effect of the prepolymer will tend to be obtained more prominently. If X/Y is a value of no greater than 0.3, it will be possible to inhibit increase in the molecular weight of the isocyanate group-remaining prepolymer and to maintain a manageable viscosity. Synthesis time for the isocyanate group-remaining prepolymer can be shortened by adding a catalyst, but room temperature (25° C.) or thermal reaction under non-catalytic conditions is preferred to avoid coloration of the polymer.

From the viewpoint of storage stability, the resin composition of this embodiment is preferably a two-solution type resin composition comprising an isocyanate component solution B containing the aforementioned aliphatic or alicyclic polyisocyanate, and a polyol component solution A containing a saturated polyol. Here, the “two-solution type resin composition” comprises at least 2 different compositions, such as component A and component B, which may be reacted to obtain a cured product.

The mixing ratio of the isocyanate component and polyol component is preferably a hydroxyl equivalent/isocyanate group equivalent ratio of 0.7 to 1.3, and more preferably 0.8 to 1.1. If the ratio is outside of the range of 0.7 to 1.3, the heat resistance, optical characteristics and mechanical properties of the cured product will tend to be lowered.

(Antioxidant)

The antioxidant (C) is preferably a phosphorus-based, sulfur-based or hindered phenol-based antioxidant, with hindered phenol-based and sulfur-based antioxidants being especially preferred for use, either alone or in combinations of several types. Examples of hindered phenol-based antioxidants include, for example, 3,9-bis[2-{3-(3-tert-butyl-4-hydroxy-5-methylphenyl)propionyl}-1,1-dimethylethyl]-2,4,8,10-tetraoxaspiro[5,5]undecane, benzenepropanoic acid, 3,5-bis(1,1-dimethylethyl)-4-hydroxy, C7-C9 side chain alkyl esters, 4,4′-butylidenebis(6-tert-butyl-3-methylphenol), 2,6-di-tert-butyl-4-methylphenol and 2,2′-methylenebis(6-tert-butyl-4-methylphenol), with 3,9-bis[2-{3-(3-tert-butyl-4-hydroxy-5-methylphenyl)propionyl}-1,1-dimethylethyl]-2,4,8,10-tetraoxaspiro[5,5]unde cane, benzenepropanoic acid, 3,5-bis(1,1-dimethylethyl)-4-hydroxy and C7-C9 side chain alkyl esters being especially preferred.

The content of the antioxidant (C) in the urethane resin composition is preferably 0.05 to 5 wt % and most preferably 0.05 to 0.3 wt %. If the antioxidant content is less than 0.05 wt % the effect as an antioxidant will tend to be reduced, while a content of greater than 5 wt % will tend to reduce the solubility and cause deposition during curing.

(Release Agent)

Solution A and/or solution B for this embodiment preferably further contain, as a (D) release agent, a saturated fatty acid represented by the following formula (1), or the saturated fatty acid with a silicone-caprolactone block copolymer represented by the following formula (3) or a polyether-modified silicone-caprolactone block copolymer represented by the following formula (4). In formula (3), R² and R³ each independently represent a divalent hydrocarbon group or a polyether chain. The compounds of the following formulas (3) and (4) also function as dispersing agents.

[Chemical Formula 12]

R¹—COOH (1)

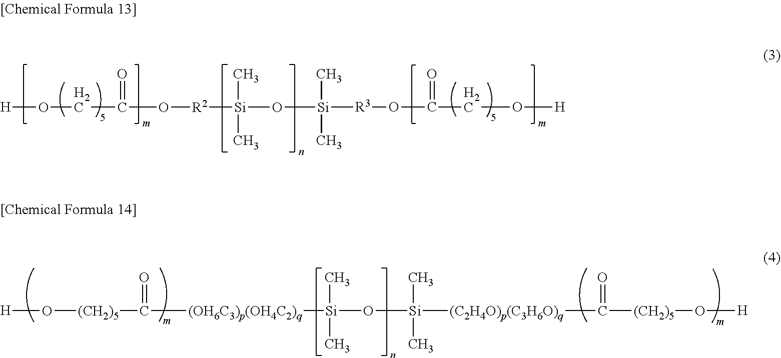

The aforementioned saturated fatty acids include saturated fatty acids such as caprylic acid, pelargonic acid, lauric acid, myristic acid, pentadecylic acid, palmitic acid, margaric acid, stearic acid, isostearic acid, arachidic acid, behenic acid, lignoceric acid, cerotic acid and montanic acid, and unsaturated fatty acids such as palmitoyl acid, oleic acid, vaccenic acid, linolic acid, eleostearic acid and nervonic acid.

The total number of carbon atoms of R¹ in formula (1) will usually be 7 to 28, and is preferably 10 to 22 and more preferably 14 to 18. Especially preferred is C17 isostearic acid, which is liquid and allows the viscosity of the urethane resin composition to be adjusted.

In the silicone-caprolactone block copolymer represented by formula (3) or the polyether-modified silicone-caprolactone block copolymer represented by formula (4), the ratio m/n in the formulas is preferably 0.5 to 1.0 and more preferably 0.6 to 0.9. If the m/n ratio is 0.5 or greater, the compatibility with other materials will be high, and problems such as opacity in the cured object can be minimized. If the m/n ratio is no greater than 1.0, it will be possible to obtain excellent releasability from molding dies. The silicone-caprolactone block copolymer preferably has a weight-average molecular weight of no greater than 16000, from the viewpoint of excellent solubility. Also preferably, the structure is such that the polyether chains are connecting between the silicone main chains and caprolactone chains of the polyether-modified silicone-caprolactone block copolymer, the connected sections having propylene oxide and/or ethylene oxide added at the ends of the silicone main chains.

Also, in formula (4), preferably p and q are 1 or greater, and either p or q is 2 or greater. If the silicone main chains and caprolactone chains are connected in the aforementioned range for p and q, the polyether-modified silicone-caprolactone block copolymer will be able to be sufficiently compatibilized in the urethane resin composition comprising the polyol component (solution A) and polyisocyanate component (solution B), and it will be possible to obtain both excellent releasability and transparency. It will also be possible to inhibit aggregation of the highly crystalline caprolactone, and the polyether-modified silicone-caprolactone block copolymer will be stably present in solution B without deposition. Below the range for p and q, however, that is, if p or q is less than 1 or if p and q are both less than 2, the polyether-modified silicone-caprolactone block copolymer will tend to be non-compatible in the urethane resin composition comprising the polyol component and polyisocyanate component, and the transparency of the cured product may be insufficient.

If the urethane resin composition includes the aforementioned saturated fatty acid and silicone-caprolactone block copolymer, it will be possible to improve the releasability from molding dies when the urethane resin composition is molded to obtain a cured object.

The saturated fatty acid or polyether-modified silicone-caprolactone block copolymer may be added alone, similar to the other components, but heating it with the isocyanate component solution B to transparent homogeneity can provide even more satisfactory results for releasability and transparency.

The release agent content is preferably 0.01 to 5.0 wt %, based on the total of the polyol component and polyisocyanate component. If the release agent content is at least 0.01 wt %, the releasability from molding dies will tend to be superior, and if it is no greater than 5.0 wt %, reduction in the heat resistance including glass transition temperature of the cured object will tend to be minimized. The saturated fatty acid and the silicone-caprolactone block copolymer are preferably used in combination. From the viewpoint of solubility, the saturated fatty acid and silicone-caprolactone block copolymer are preferably added to solution B, as the isocyanate component.

The dispersing agent (E) is a compound represented by the following formula (2), having a weight-average molecular weight Mw of no greater than 16000.

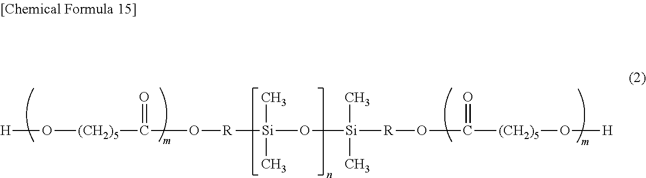

Here, R is a divalent hydrocarbon group, and m and n are positive integers. This is with the proviso that the m/n ratio is 0.6 to 0.8. If the m/n ratio is less than 0.6 the compatibility will tend to be poor and the transparency reduced, while if it is greater than 0.8 the releasability will tend to be reduced. Also, the solubility will tend to be reduced if the weight-average molecular weight Mw is greater than 16000.

The amount of the dispersing agent (E) added is 0.1 to 5.0 wt %, preferably 1.0 to 4.0 wt % and more preferably 2.0 to 3.0 wt %. If the amount of dispersing agent added is less than 0.1 wt %, the improving effect on the releasability and transparency will be low compared to using the release agent (D) alone, and if it is greater than 5.0 wt % the transparency will tend to be reduced.

(Adhesion-Imparting Agent and Compound with Thiol Group)

In order to obtain adhesion with silver platings or palladium platings of lead frames, it is preferred to add a compound with a thiol group as an adhesion-imparting agent. Preferred compounds with thiol groups include compounds thiol group-containing silane coupling agents such as γ-mercaptopropylmethyldimethoxysilane and γ-mercaptopropyltrimethoxysilane, and compounds with 2 or more thiol groups (hereunder reference to as “polythiols”), and examples include compounds having a thiol group bonded to a primary carbon, compounds having a thiol group bonded to a secondary carbon, and compounds having one or more thiol groups bonded to a primary carbon and one or more thiol groups bonded to a secondary carbon.

Compounds having a thiol group bonded to a primary carbon include compounds having 3 thiol groups, such as tris-[(3-mercaptopropionyloxy)-ethyl]-isocyanurate and trimethylolpropane tris-(3-mercaptopropionate); compounds having 4 thiol groups, such as pentaerythritol tetrakis-3-mercaptopropionate; and compounds having 6 thiol groups, such as dipentaerythritol hexa-3-mercaptopropionate.

Compounds having a thiol group bonded to a secondary carbon include compounds having 2 thiol groups, such as 1,4-bis-(3-mercaptobutyloxy)butane; compounds having 3 thiol groups, such as 1,3,5-tris-(3-mercaptobutyloxyethyl)-1,3,5-triazine-2,4,6(1H,3H,5H)-trione; and compounds having 4 thiol groups, such as pentaerythritol tetrakis-3-mercaptobutyrate.

The thiol compound content is preferably 0.01 to 2.0 wt %, more preferably 0.1 to 2.0 wt %, even more preferably 0.1 to 1.0 wt % and most preferably 0.1 to 0.5 wt %, based on the total weight of the polyol component and isocyanate component. If the thiol compound content is 0.01 wt % or greater, the adhesiveness with silver platings will tend to be improved, and if it is no greater than 2.0 wt %, the heat resistance including the glass transition temperature of the cured object will tend to be maintained. If the urethane resin composition includes the aforementioned release agent, it will be possible to improve the adhesiveness between the cured object and silver platings without impairing the releasability from molding dies.

The polythiol preferably further comprises a sulfide group. If the polythiol further has a sulfide group, it will possible to further improve adhesiveness between the obtained cured object and silver platings. Polythiols with sulfide groups include 2,2′-dimercaptodiethyl sulfide and the like.

Since the thiol compound reacts with the isocyanate component, it is preferably added to solution A, which is the polyol component.

(Inorganic Filler)

Solution A or solution B of this embodiment, or the urethane resin composition, may further comprise an inorganic filler. The inorganic filler is preferably silica in order to maintain optical transparency of the cured object, and it is preferred to use silica powders (silica fillers) with different particle sizes in admixture for high-density filling in the urethane resin composition. If the urethane resin composition includes an inorganic filler, the thermal expansion coefficient of the cured object will approach the thermal expansion coefficient of a lead frame of a photosemiconductor device, thus helping to prevent detachment from lead frames in heat resistance testing and temperature cycling testing. Also, if the urethane resin composition includes a fluorescent material as an inorganic filler, it will be possible to obtain a white color in combination with a blue light emitting diode (LED).

There may also be added to the urethane resin composition, in addition to the components mentioned above, hindered amine-based and other light stabilizers, ultraviolet absorbers, organic fillers, coupling agents, polymerization inhibitors, curing catalysts, curing accelerators, and the like. From the viewpoint of moldability, a plasticizer, antistatic agent, flame retardant or the like may also be added. These are preferably liquid from the viewpoint of ensuring optical transparency of the cured urethane resin, but when a solid additive is used, it preferably has a particle size of no greater than the wavelength to be used in the photosemiconductor device.

Examples of curing accelerators include zirconium or aluminum organometallic catalysts, dibutyltin laurate, DBU phenol salt, octylic acid salts, amines, imidazoles and the like, but from the viewpoint of coloration, it is particularly preferred to use an organometallic catalyst, such as aluminum sec-butyrate, ethyl acetoacetate-aluminum diisopropylate, zirconium tributoxyacetylacetonate or zirconium tetraacetylacetonate.

The content of the curing accelerator in the urethane resin composition is preferably 0 to 1.0 wt % and most preferably 0 to 0.1 wt %. If the catalyst content is greater than 1 wt %, the curing speed will be too fast and handling of the resin will become difficult. A higher amount of addition also causes more coloration.

A curing catalyst may be added to the urethane resin composition of this embodiment to increase the curability. As curing catalysts there may be used organometallic catalysts of zinc, zirconium, aluminum or the like, tin-based catalysts such as dibutyltin laurate, DBU (1,8-diazabicyclo[5,4,0]undecane-7-ene) phenol salt, octylic acid salts, amines, imidazoles, and the like. Of these, zinc stearate is preferred for heat coloration resistance and excellent viscosity stability of the urethane resin composition at room temperature. The curing catalyst content is preferably 0.001 to 1 wt %, more preferably 0.001 to 0.5 wt % and even more preferably 0.002 to 0.1 wt % with respect to the total amount of the urethane resin composition. If the curing catalyst content is at least 0.001 wt % the curing acceleration effect will tend to be exhibited, and if it is no greater than 1 wt %, opacity of the cured object will tend to be minimized. Addition of a curing catalyst can increase the curability of the urethane resin composition.

A conventionally known product may be used as the zinc stearate with a bulk density of no greater than 0.12 g/ml. If the bulk density exceeds 0.12 g/ml, slight opacity may be seen and the transmittance will be reduced, even for the cured urethane resin. A small bulk density represents, indirectly, a small particle size and a large surface area.

The zinc stearate with a bulk density of no greater than 0.12 g/ml preferably has a maximum primary particle size of no greater than 2 μm, and a mean primary particle size of no greater than 1 μm.

In a two-solution type resin composition, zinc stearate with a bulk density of no greater than 0.12 g/ml generally tends to dissolve in the polyisocyanate more readily than the polyol, and therefore it is preferably contained in solution B, which is the isocyanate component.

The content of the zinc stearate with a bulk density of no greater than 0.12 g/ml is preferably 0.001 to 1 wt % and more preferably 0.002 to 0.1 wt %, with respect to the total weight of the resin composition. If the content is less than 0.001 wt % the curing acceleration effect will be low, while if it is greater than 1 wt % the cured product will tend to have slight opacity.

The coupling agent may be a silane coupling agent with an epoxy group, ureido group, or the like. The coupling agent content in the urethane resin composition is preferably 0.1 to 2 wt % with respect to the total of the polyol component and polyisocyanate component. If a coupling agent is included in the urethane resin composition, adhesiveness between the cured object and the silver plating of the lead frame, light emitting elements, wires, inorganic fillers and the like will be improved.

The resin composition of this embodiment preferably has a gelling time of no longer than 120 seconds at 165° C., and a gelling time of no longer than 40 seconds is particularly preferred for efficient application in reaction/injection/molding methods or compression molding methods, which have excellent productivity.

The urethane resin composition of this embodiment preferably has a gelling time of 25 to 200 seconds at 165° C. A gelling time within this range will allow resin sealing of photosemiconductor elements and fabrication of optical members to be accomplished by liquid transfer molding under essentially the same molding conditions as conventional solid transfer molding. If the gelling time is shorter than 25 seconds, the resin composition solution will harden before it has completely flowed through the fluid channel in the molding die, thus tending to create unfilled sections or voids in the molded article. On the other hand, if the gelling time is longer than 200 seconds, an insufficiently cured molded article will tend to be formed.

The urethane resin composition of the embodiment described above has high optical transparency for its cured products, and excellent heat resistance, optical characteristics such as light-coloring resistance and mechanical properties, and it is suitable as a sealing resin for photosemiconductor elements including light emitting diodes (LED), phototransistors, photo diodes and solid pickup elements. Also, using the resin composition of the invention allows resin sealing of photosemiconductor elements to be accomplished efficiently by liquid transfer molding, and allows highly efficient production of photosemiconductors such as LEDs.

(Cured Object)

The cured object of this embodiment can be produced by mixing solution A containing a polyol component and solution B containing a polyisocyanate component, and heating the mixture for reaction. Each of the components other than the polyol component and the polyisocyanate component in the urethane resin composition may be included in either solution A or solution B, but the adhesion-imparting agent (the silane coupling agent with a thiol group or compound with a thiol group) is preferably included in solution A before solution A and solution B are mixed. Also, if the release agent is used as a molten mixture together with solution B before mixing solution A and solution B, it will be possible to obtain an excellent effect for compatibility during mixing, and an even more excellent effect for releasability and optical transparency. The inorganic filler may be added to the urethane resin composition after solution A and solution B have been mixed. The mixing ratio of the polyol component and the polyisocyanate component, and the mixing ratio of the hydroxyl group-remaining prepolymer and the isocyanate group-remaining prepolymer, is preferably 0.7 to 1.3 and more preferably 0.8 to 1.1, as the ratio of (total hydroxyl equivalents of polyol and hydroxyl group-remaining prepolymer)/(total isocyanate equivalents of polyisocyanate and isocyanate group-remaining prepolymer) in the urethane resin composition. If the mixing ratio is in the range of 0.7 to 1.3, the cured object will tend to have improved heat resistance, optical characteristics and mechanical properties.

The urethane resin composition obtained as described above may be used for sealing of a photosemiconductor element by liquid transfer molding or compression molding, to produce a photosemiconductor device. During this time, the urethane resin composition preferably has a gelling time of 25 to 200 seconds at 165° C. A gelling time within this range will allow production to be accomplished under essentially the same molding conditions as conventional solid transfer molding. If the gelling time is shorter than 25 seconds, the molten urethane resin composition may cure before sufficiently filling the fluid channel of the molding die (hereunder referred to simply as “die”), tending to create unfilled sections or voids in the molded cured object. On the other hand, if the gelling time is longer than 200 seconds, an insufficiently cured molded article will tend to be formed.

The cured resin obtained by the resin composition of this embodiment has excellent transparency, and preferably the transmittance of its 1 mm-thick cured product at 589 nm is 90% or greater.

The resin composition of the invention described above has excellent reactivity between the isocyanate groups and hydroxyl groups, low coloration of the cured product and an excellent pot life compared to using other organic tin or carboxylic acid metal catalysts.

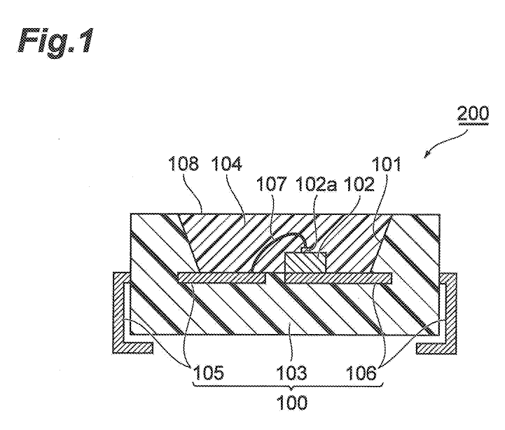

FIG. 1 is a schematic cross-sectional view of a surface mounted LED package, as a preferred example of a photosemiconductor device produced using a urethane resin composition of the invention. The surface mounted LED package 200 shown in FIG. 1 comprises a semiconductor light emitting element 102, a sealed body comprising a cured product obtained by curing a urethane resin composition of the invention (transparent sealing resin) 104, and a molded resin 100. The molded resin 100 has a structure in which a pair of leads 105, 106 formed from a lead frame are molded by a resin section 103 composed of a thermosetting resin.

An opening 101 is formed in the resin section 103, and a semiconductor light emitting element 102 is mounted inside it. It is then sealed with the sealed body 104 so as to enclose the semiconductor light emitting element 102. The semiconductor light emitting element 102 is mounted on a lead 106.

An electrode 102a on the semiconductor light emitting element 102 and the lead 105 are connected by a wire 107. Luminescence is produced when electric power is supplied to the semiconductor light emitting element 102 through the two leads 105, 106, and the luminescence passes through the sealed body 104 and exits from a light extraction surface 108.

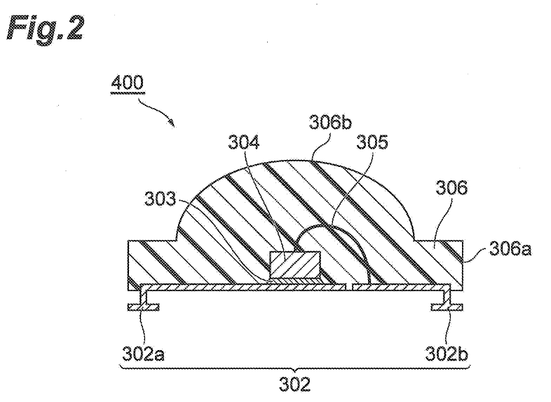

FIG. 2 is a schematic cross-sectional view showing an embodiment of a photosemiconductor device. The photosemiconductor device 400 shown in FIG. 2 has a pair of lead frames 302 (302a, 302b), a bonding member 303 provided on one of the lead frames 302a, a photosemiconductor element 304 provided on the bonding member 303, a wire 305 electrically connecting the photosemiconductor element 304 and the other lead frame 302b, and a sealing member 306 sealing parts of the pair of lead frames 302, the bonding member 303, the photosemiconductor element 304 and the wire 305. Such a photosemiconductor device 400 is sometimes referred to a surface mount.

The lead frames 302 consist of the one lead frame 302a and the other lead frame 302b. The lead frames 302 are members composed of a conductive material such as a metal, and their surfaces are usually covered with a silver plating. The one lead frame 302a and the other lead frame 302b are separated from each other. The bonding member 303 is a member that anchors the one lead frame 302a and the photosemiconductor element 304 by bonding, while also providing electrical connection between them. The bonding member 303 is formed from a silver paste, for example.

The photosemiconductor element 304 may be a light emitting diode element that emits light when a voltage is applied in the forward direction. The wire 305 is a conductive wire such as a metal small-gauge wire, that can electrically connect the photosemiconductor element 304 and the other lead frame 302b.

The sealing member 306 is formed by a cured object of the aforementioned urethane resin composition. The sealing member 306 performs a function of protecting the photosemiconductor element 304 from external air while also extracting light emitted from the photosemiconductor element 304 to the outside, and it is therefore a material with high optical transparency. For this embodiment, light emitted from the photosemiconductor element 304 is aggregated by a lens section 306b where the sealing member 306 is formed into a convex lens shape.

For the photosemiconductor device 400 of this embodiment as described above, liquid transfer molding or compression molding may be employed for some of the production steps, whereby the molding time can be shortened and productivity increased. By employing liquid transfer molding or compression molding, it is also possible to obtain an effect of imparting a lens shape that can improve light extraction efficiency, as shown in FIG. 2.

The photosemiconductor device 400 need only be provided with a photosemiconductor element and a sealing member sealing it, and a lamp-type may be used instead of the surface mount-type described above.

Production of the photosemiconductor device 400 of FIG. 2 will now be explained as an example of a preferred embodiment of the method for producing a photosemiconductor device. The method for producing the photosemiconductor device 400 of this embodiment comprises a step of curing and molding the aforementioned urethane resin composition by liquid transfer molding or compression molding to form the sealing member 306 of the photosemiconductor device 400.

First, a structure provided with a subassembly of parts is prepared. The subassembly comprises a pair of lead frames 302 (302a, 302b), a bonding member 303 provided on one lead frame 302a, a photosemiconductor element 304 formed on the bonding member 303, and a wire 305 electrically connecting the photosemiconductor element 304 and the other lead frame 302b. First, the structure is situated at a prescribed position in the cavity formed by the die of the molding apparatus. The molding apparatus is one to be used for liquid transfer molding or compression molding, and the cavity formed by the die is not particularly restricted so long as it forms the intended cured object shape.

Next, the urethane resin composition is prepared and filled into the pot of the molding apparatus, a plunger is activated, and the urethane resin composition is injected from the pot into the cavity of the die that has been heated to the prescribed temperature, through fluid channels including a runner, gate and the like. The die will usually be composed of a separable upper die and lower die, which are connected to form a cavity. Next, the urethane resin composition is held for a prescribed time in the cavity to cure the cavity-filling urethane resin composition on the structure. This molds the cured urethane resin composition into the intended shape, sealing the subassembly of parts while also firmly bonding the structure.

The mold temperature is preferably set to a temperature which allows the urethane resin composition to have a high flow property in the fluid channel, and permits rapid curing of the urethane resin is composition in the cavity. The temperature will depend on the constitution of the urethane resin composition, but it may be 120-200° C., for example. The injection pressure for injection of the urethane resin composition into the cavity is preferably set to a pressure which allows the urethane resin composition to fill the entire cavity interior without voids, and specifically, it is preferably 2 MPa or greater. An injection pressure of at least 2 MPa will tend to prevent unfilled sections in the cavity and generation of voids in the sealing member 306.

In order to facilitate removal of the cured urethane resin composition (sealing member 306) from the die, a release agent may be coated or sprayed onto the inner wall surface of the die forming the cavity. Also, in order to minimize generation of voids in the cured object, a known reduced-pressure molding apparatus may be used, which allows pressure reduction inside the cavity.

Next, the structure and the cured urethane resin composition bonded to it are removed from the cavity, and the lead frame is cut to separate the individual subassembly parts. Thus, there is obtained a photosemiconductor device comprising the cured urethane resin composition as a sealing member sealing the subassembly parts.

Since a liquid transfer molding method or compression molding method is used in the method for producing a photosemiconductor device of the embodiment described above, a short curing time may be set and productivity of the photosemiconductor device can be improved. In addition, using such a molding method allows any desired shape to be produced for the cured object.

When the urethane resin composition of this embodiment is to be used to produce a photosemiconductor device by a casting method or potting method, it is preferably subjected to heat curing for about 1 to 10 hours at 60 to 150° C. and more preferably for about 1 to 10 hours at 80 to 150° C., although this will depend on the types, combinations and addition amounts of the components. In order to reduce internal stress generated by rapid curing reaction, the curing temperature is preferably raised in a stepwise manner.

The cured urethane resin composition of the embodiment described above has high optical transparency, and excellent heat resistance, optical characteristics such as light-coloring resistance and mechanical properties, and it is suitable as a sealing member for photosemiconductor elements including light emitting diodes (LED), phototransistors, photo diodes and solid pickup elements. Also, the urethane resin composition of this embodiment can be used for efficient sealing of photosemiconductor elements by liquid transfer molding in a homogeneous manner without problems such as air bubbles, and it allows highly efficient production of photosemiconductor devices such as LED packages.

### EXAMPLES

The present invention will now be described in greater detail by examples, with the understanding that the invention is not limited thereto in any way. Unless otherwise specified, the mixing proportions are represented as parts by weight.

“Study 1”

The following compounds were used for Examples 1-3 and Comparative Examples 1-5.

Polyol (A1): Polycaprolactone triol with a molecular weight of 300 and a hydroxyl value of 540 (KOH·mg/g).

Polyol (A2): Trimethylolpropane (Perstorp Co.).

Isocyanate (B1): 1,3-bis(Isocyanatomethyl)cyclohexane (trade name: TAKENATE 600 by Mitsui Takeda Chemicals, Inc.).

Isocyanate (B2): 4,4′-Methylenebis(cyclohexyl isocyanate) (H12MDI by Degussa Japan).

Isocyanate (B3): Isophorone diisocyanate (trade name: VESTANAT IPDI by Degussa Japan).

Isocyanate (B4): Norbornane diisocyanate (trade name: COSMONATE NBDI by Mitsui Takeda Chemicals, Inc.).

Isocyanate (B5): 70 wt % Butyl acetate solution of isocyanurate-type isocyanate, as an isophorone diisocyanate trimer (trade name: DESMODUR Z4470BA by Sumika Bayer Urethane Co., Ltd.).

Zinc stearate (C1): Zinc stearate with bulk density of 0.10 g/ml and mean particle size of 0.9 μm (trade name: MZ-2 by NOF Corp.).

Antioxidant (D1): [2-{3-(3-tert-Butyl-4-hydroxy-5-methylphenyl)propionyl}-1,1-dimethylethyl]-2,4,8,10-tetraoxaspiro[5,5]undecane (hindered phenol-based antioxidant, trade name: SUMIRIZER GA-80 by Sumitomo Chemical Co., Ltd.)

### Example 1

After adding 9.7 parts by weight of polyol (A1) to 27.1 parts by weight of isocyanate (B1) and 24.4 parts by weight of isocyanate (B2), the mixture was reacted at 80° C. for 6 hours under a nitrogen atmosphere to prepare an isocyanate group-remaining prepolymer. To the isocyanate group-remaining prepolymer there was added 0.05 part by weight of zinc stearate (C1) as a curing catalyst to prepare an isocyanate component solution B.

Also, 0.1 part by weight of an antioxidant (D1) was added to 38.7 parts by weight of polyol (A1), and the mixture was heated and stirred at 80° C. for 1 hour under a nitrogen atmosphere to prepare a transparent, homogeneous polyol component solution A.

Next, 61.25 parts by weight of solution A and 38.8 parts by weight of solution B were mixed and stirred at room temperature to transparent homogeneity to prepare a resin composition.

### Example 2

After adding 4.5 parts by weight of polyol (A2) to 54.6 parts by weight of isocyanate (B3), the mixture was reacted at 80° C. for 6 hours under a nitrogen atmosphere to prepare an isocyanate group-remaining prepolymer. To the isocyanate group-remaining prepolymer there was added 0.05 part by weight of zinc stearate (C1), to prepare an isocyanate component solution B.

Also, 0.1 part by weight of an antioxidant (D1) was added to 40.9 parts by weight of polyol (A1), and the mixture was heated and stirred at 80° C. for 1 hour under a nitrogen atmosphere to prepare a transparent, homogeneous polyol component solution A.

Next, 41 parts by weight of solution A and 59.2 parts by weight of solution B were mixed and stirred at room temperature to transparent homogeneity to prepare a resin composition.

### Example 3

After adding 8.1 parts by weight of polyol (A2) to 18.1 parts by weight of polyol (A1), the mixture was heated and stirred to prepare a polyol component solution A.

Next, 1.5 parts by weight of polyol (A2) was mixed with 15.2 parts by weight of isocyanate (B1), and the mixture was heated and stirred at 100° C. for 3 hours under a nitrogen atmosphere to prepare an isocyanate group-remaining prepolymer. After mixing 16.7 parts by weight of the isocyanate group-remaining prepolymer, 15.9 parts by weight of isocyanate (B4), 41.2 parts by weight of isocyanate (B5) and 0.1 part by weight of an antioxidant (D1), the butyl acetate was distilled off to obtain a homogeneous resin solution. To this resin solution there was added 0.05 part by weight of zinc stearate (C1) as a catalyst, and the mixture was heated and stirred to prepare a polyisocyanate component solution B.

Solution A and solution B were mixed and stirred at room temperature to transparent homogeneity to prepare a resin composition.

### Comparative Example 1

A resin composition was prepared in the same manner as Example 1, except that no zinc stearate (C1) was used.

### Comparative Example 2

A resin composition was prepared in the same manner as Example 1, except that 0.05 part by weight of dibutyltin dilaurate (product of Showa Chemical Industry Co., Ltd.) was used instead of zinc stearate (C1).

### Comparative Example 3

A resin composition was prepared in the same manner as Example 1, except that 0.05 part by weight of a bismuth-based catalyst (C3: trade name: K-KAT348 by Kusumoto Chemicals, Ltd.) was used instead of zinc stearate (C1).

### Comparative Example 4

A resin composition was prepared in the same manner as Example 1, except that 0.05 part by weight of zinc stearate with a bulk density of 0.15 g/ml (trade name: SZ-2000 by Sakai Chemical Industry Co., Ltd.) was used instead of zinc stearate (C1).

### Comparative Example 5

A resin composition was prepared in the same manner as Example 1, except that 0.05 part by weight of zinc stearate with a bulk density of 0.25 g/ml (trade name: SZ-P by Sakai Chemical Industry Co., Ltd.) was used instead of zinc stearate (C1).

[Evaluation of Resin Compositions]

The resin compositions obtained in Examples 1-3 and Comparative Examples 1-5 were evaluated for gelling time, pot life and molded article transparency, by the methods described below. The results are shown in Table 1.

(Gelling time)

The gelling time was determined using a gelling tester by SYSTEM SEIKO, setting the hot plate temperature to 165° C. and measuring the time until gelling of the urethane resin composition.

(Pot Life)

The pot life was determined by allowing the mixture of solution A and solution B to stand at room temperature and measuring the time until the viscosity reached twice the initial viscosity.

(Light Transmittance (Transparency))

The resin composition was molded into a 40×40×1 mm tabular cured product using a liquid transfer molding apparatus under conditions with a mold temperature of 165° C., an injection pressure of 10 MPa and a molding time of 90 seconds, to obtain a molded article. The molded article was subjected to postcuring at 150° C. for 3 hours using an oven to obtain a test piece. The light transmittance of the obtained test piece was determined by measuring the light transmittance at a wavelength of 589 nm using a spectrophotometer.

TABLE 1

| | | | | Comp. | Comp. | Comp. | Comp. | Comp. |
|---|---|---|---|---|---|---|---|---|
| | Example 1 | Example 2 | Example 3 | Ex. 1 | Ex. 2 | Ex. 3 | Ex. 4 | Ex. 5 |
| Bulk density | 0.10 | 0.10 | 0.10 | — | — | — | 0.15 | 0.25 |
| (g/ml) | | | | | | | | |
| Gelling time | 29 | 21 | 20 | 140 | 15 | 15 | 33 | 35 |
| (sec) | | | | | | | | |
| Pot life (min) | 240 | 180 | 180 | 240 | 10 | 15 | 180 | 180 |
| Transmittance | 90.2 | 90.2 | 90.0 | 90.2 | Unmeasurable | Unmeasurable | 88.8 | 87.7 |
| (%) | | | | | | | | |

As shown in Table 1, comparison between Example 1 and Comparative Example 1 clearly shows that using zinc stearate with a bulk density of no greater than 0.12 g/ml can shorten the gelling time with an equivalent pot life, and also allows equivalent transmittance to be obtained. In Examples 2 and 3 as well, the gelling times, pot lives and transmittances were similar properties as in the example.

In contrast, Comparative Examples 2 and 3 had short gelling times but short pot lives and also inferior manageability.

Also, Comparative Examples 4 and 5 had gelling times and pot lives that were similar to Example 1, but the transmittances were reduced. Comparative Examples 2 and 3 had excessively fast gelling times and did not allow formation of transmittance measuring samples.

“Study 2”

The following compounds were used for Examples 4-10 and Comparative Examples 6-10.

Polyol (A1): Polycaprolactone triol with molecular weight of 300 and hydroxyl value of 540 (KOH·mg/g) (PLACCEL 303 by Daicel Chemical Industries, Ltd.).

Polyol (A2): Trimethylolpropane (Perstorp Co.)

Isocyanate (B1): 4,4′-Methylenebis(cyclohexyl isocyanate) (DESMODUR W by Sumitomo Bayer Urethane Co., Ltd.).

Isocyanate (B2): Norbornane diisocyanate (trade name: COSMONATE NBDI by Mitsui Takeda Chemicals, Inc.).

Isocyanate (B3): 70 wt % Butyl acetate solution of isocyanurate-type isocyanate, as an isophorone diisocyanate trimer (VESTANAT (R)T1890: by Degussa).

Isocyanate (B4): Aliphatic primary diisocyanate (TAKENATE 600 by Mitsui Chemical Polyurethane Co., Ltd.).

Antioxidant (C1): 3,9-bis[2-{3-(3-tert-Butyl-4-hydroxy-5-methylphenyl)propionyl}-1,1-dimethylethyl]-2,4,8,10-tetraoxaspiro[5,5]undecane (hindered phenol-based antioxidant: SUMIRIZER GA-80 by Sumitomo Chemical Co., Ltd.)

Release agent (D1): Isostearic acid (Compound of formula (1) wherein R¹ is a C18 branched chain alkyl group. ISOSTEARIC ACID EX by Kokyu Alcohol Kogyo Co., Ltd.).

Release agent (D2): Stearic acid (Compound of formula (1) wherein R¹ is a C17 straight-chain alkyl group. NAA-173K by NOF Corp.).

Release agent (D3): Montanic acid ester (Licowax-E by Clariant Japan).

Release agent (D4): Caprylic acid (Compound of formula (1) wherein R¹ is a C8 straight-chain alkyl group. LUNAC 8-98 by Kao Corp.).

Release agent (D5): Lauric acid (Compound of formula (1) wherein R¹ is a C12 straight-chain alkyl group. LUNAC L-98 by Kao Corp.).

Dispersing agent (E1): Polyether-modified silicone (Compound of formula (2) wherein m/n=0.7, weight-average molecular weight Mw=9000, SLJ02 by Asahi Kasei Wacker Co., Ltd.).

Dispersing agent (E2): Polyether-modified silicone (Compound of formula (2) wherein m/n=0.8, Mw=6000, SLJ01 by Asahi Kasei Wacker Co., Ltd.).

Dispersing agent (E3): Polyester-modified silicone oil (X-22-715 by Shin-Etsu Chemical Co., Ltd.).

Curing accelerator (1): Zinc stearate

### Example 4

After adding 10.6 parts by weight of polyol (A2) to 19.7 parts by weight of polyol (A1), the mixture was heated and stirred to prepare a homogeneous polyol component solution A.

Separately, 1.0 part by weight of polyol (A2) was added to 14.4 parts by weight of isocyanate (B1), and the mixture was reacted at 100° C. for 1 hour under a nitrogen atmosphere to prepare an isocyanate group-remaining prepolymer.

Also, 15.4 parts by weight of the isocyanate group-remaining prepolymer, 15.1 parts by weight of isocyanate (B2), 39.2 parts by weight of isocyanate (B3) and 0.1 part by weight of an antioxidant (C1) were mixed and then the butyl acetate was heated and removed under reduced pressure to prepare an isocyanate component solution P_{B}.

The isocyanate component solution P_{B}, 2.0 parts by weight of a release agent (D1) and 2.0 parts by weight of a dispersing agent (E1) were hot melted at 150° C. for 10 minutes. They were then stirred at 2000 rpm for 3 minutes, using an Awatori Rentaro (trade name of Thinky Corp.). This was followed by heating for 5 minutes in a hot water bath at 100° C., and stirring at 2000 rpm for 3 minutes. Curing accelerator (1) was then added at 0.05 part by weight, and stirring was continued at 2000 rpm for 3 minutes. This was designated as solution C1.

After mixing 14.3 parts by weight of the polyol component solution A and 37.8 parts by weight of solution C1 (hydroxyl equivalent/isocyanate group equivalent ratio: 1.0), an Awatori Rentaro (trade name of Thinky Corp.) was used for reduced-pressure defoaming to obtain a urethane resin composition for Example 4.

### Example 5

After adding 10.6 parts by weight of polyol (A2) to 19.7 parts by weight of polyol (A1), the mixture was heated and stirred to prepare a homogeneous polyol component solution A.

Separately, 1.0 part by weight of polyol (A2) was added to 14.4 parts by weight of isocyanate (B1), and the mixture was reacted at 100° C. for 1 hour under a nitrogen atmosphere to prepare an isocyanate group-remaining prepolymer.

Also, 15.1 parts by weight of isocyanate (B2), 39.2 parts by weight of isocyanate (B3) and 0.1 part by weight of an antioxidant (C1) were added to 15.4 parts by weight of the isocyanate group-remaining prepolymer and mixed therewith, and then the butyl acetate was heated and removed under reduced pressure to prepare an isocyanate component solution P_{B}.

The isocyanate component solution P_{B}, 2.0 parts by weight of release agent (D2) and 2.0 parts by weight of dispersing agent (E2) were melt mixed, and then 0.05 part by weight of curing accelerator (1) was added to obtain solution C2.

After then mixing 30.3 parts by weight of the polyol component solution A and 74.3 parts by weight of solution C2 (hydroxyl equivalent/isocyanate group equivalent ratio: 1.0), the mixture was subjected to reduced-pressure defoaming to obtain a urethane resin composition for Example 5.

### Example 6

After adding 10.6 parts by weight of polyol (A2) to 19.7 parts by weight of polyol (A1), the mixture was heated and stirred to prepare a homogeneous polyol component solution A.

Separately, 1.0 part by weight of polyol (A2) was added to 14.4 parts by weight of isocyanate (B1), and the mixture was reacted at 100° C. for 1 hour under a nitrogen atmosphere to prepare an isocyanate group-remaining prepolymer.

Also, 15.4 parts by weight of the isocyanate group-remaining prepolymer, 15.1 parts by weight of isocyanate (B2), 39.2 parts by weight of isocyanate (B3) and 0.1 part by weight of an antioxidant (C1) were mixed and then the butyl acetate was heated and removed under reduced pressure to prepare an isocyanate component solution P_{B}.

The isocyanate component solution P_{B}, 2.0 parts by weight of release agent (D2) and 2.0 parts by weight of dispersing agent (E2) were melt mixed to obtain solution C3.

After then mixing 30.3 parts by weight of the polyol component solution A and 74.3 parts by weight of solution C3 (hydroxyl equivalent/isocyanate group equivalent ratio: 1.0), the mixture was subjected to reduced-pressure defoaming to obtain a urethane resin composition for Example 6.

### Example 7

For this example, 49.8 parts by weight of isocyanate (B2) was used as the isocyanate component solution B, and 50.2 parts by weight of polyol (A1) was used as the polyol component solution A.

The isocyanate component solution B, 2.0 parts by weight of release agent (D1) and 2.0 parts by weight of dispersing agent (E1) were melt mixed to obtain solution C4.

After then mixing 50.2 parts by weight of the polyol component solution A and 53.8 parts by weight of solution C4 (hydroxyl equivalent/isocyanate group equivalent ratio: 1.0), the mixture was subjected to reduced-pressure defoaming to obtain a urethane resin composition for Example 7.

### Example 8

For this example, 48.2 parts by weight of isocyanate (B4) was used as the isocyanate component solution B. Also, 51.7 parts by weight of polyol (A1) was used as the polyol component solution A.

The isocyanate component solution B, 2.0 parts by weight of release agent (D1) and 2.0 parts by weight of dispersing agent (E1) were melt mixed to obtain solution C5.

After then mixing 51.7 parts by weight of the polyol component solution A and 52.2 parts by weight of solution C5 (hydroxyl equivalent/isocyanate group equivalent ratio: 1.0), the mixture was subjected to reduced-pressure defoaming to obtain a urethane resin composition for Example 8.

### Example 9

After adding 10.6 parts by weight of polyol (A2) to 19.7 parts by weight of polyol (A1), the mixture was heated and stirred to prepare a homogeneous polyol component solution A.

Separately, 1.0 part by weight of polyol (A2) was added to 14.4 parts by weight of isocyanate (B1), and the mixture was reacted at 100° C. for 1 hour under a nitrogen atmosphere to prepare an isocyanate group-remaining prepolymer.

Also, 15.1 parts by weight of isocyanate (B2), 39.2 parts by weight of isocyanate (B3) and 0.1 part by weight of an antioxidant (C1) were added to 15.4 parts by weight of the isocyanate group-remaining prepolymer and mixed therewith, and then the butyl acetate was heated and removed under reduced pressure to prepare an isocyanate component solution P_{B}.

The isocyanate component solution P_{B}, 2.0 parts by weight of release agent (D4) and 2.0 parts by weight of dispersing agent (E1) were melt mixed, and then 0.05 part by weight of curing accelerator (1) was added to obtain solution C2.

After then mixing 30.3 parts by weight of the polyol component solution A and 74.3 parts by weight of solution C2 (hydroxyl equivalent/isocyanate group equivalent ratio: 1.0), the mixture was subjected to reduced-pressure defoaming to obtain a urethane resin composition for Example 9.

### Example 10

After adding 10.6 parts by weight of polyol (A2) to 19.7 parts by weight of polyol (A1), the mixture was heated and stirred to prepare a homogeneous polyol component solution A.

Separately, 1.0 part by weight of polyol (A2) was added to 14.4 parts by weight of isocyanate (B1), and the mixture was reacted at 100° C. for 1 hour under a nitrogen atmosphere to prepare an isocyanate group-remaining prepolymer.

Also, 15.1 parts by weight of isocyanate (B2), 39.2 parts by weight of isocyanate (B3) and 0.1 part by weight of an antioxidant (C1) were added to 15.4 parts by weight of the isocyanate group-remaining prepolymer and mixed therewith, and then the butyl acetate was heated and removed under reduced pressure to prepare an isocyanate component solution P_{B}.

The isocyanate component solution P_{B}, 2.0 parts by weight of release agent (D5) and 2.0 parts by weight of dispersing agent (E1) were melt mixed, and then 0.05 part by weight of curing accelerator (1) was added to obtain solution C2.

After then mixing 303 parts by weight of the polyol component solution A and 74.3 parts by weight of solution C2 (hydroxyl equivalent/isocyanate group equivalent ratio: 1.0), the mixture was subjected to reduced-pressure defoaming to obtain a urethane resin composition for Example 10.

### Comparative Example 6

After adding 1.0 part by weight of polyol (A2) to 14.4 parts by weight of isocyanate (B1), the mixture was reacted at 100° C. for 1 hour under a nitrogen atmosphere to prepare an isocyanate group-remaining prepolymer.

Also, 15.1 parts by weight of isocyanate (B2), 39.2 parts by weight of isocyanate (B3) and 0.1 part by weight of an antioxidant (C1) were added to 15.4 parts by weight of the isocyanate group-remaining prepolymer and mixed therewith, and then the butyl acetate was heated and removed under reduced pressure. Next, 0.05 part by weight of curing accelerator (1) was added to prepare an isocyanate component P_{B}.

Separately, 10.6 parts by weight of polyol (A2) was added to 19.7 parts by weight of polyol (A1), and the mixture was heated and stirred to prepare a homogeneous polyol component A.

After mixing 30.3 parts by weight of the polyol component solution A, 69.8 parts by weight of the isocyanate component solution P_{B}, 2.0 parts by weight of release agent (D1) and 2.0 parts by weight of dispersing agent (E1) (hydroxyl equivalent/isocyanate group equivalent ratio: 1.0), the mixture was subjected to reduced-pressure defoaming to obtain a urethane resin composition for Comparative Example 6.

### Comparative Example 7

After adding 1.0 part by weight of polyol (A2) to 14.4 parts by weight of isocyanate (B1), the mixture was reacted at 100° C. for 1 hour under a nitrogen atmosphere to prepare an isocyanate group-remaining prepolymer.

Also, 15.4 parts by weight of the isocyanate group-remaining prepolymer, 15.1 parts by weight of isocyanate (B2), 39.2 parts by weight of isocyanate (B3) and 0.1 part by weight of an antioxidant (C1) were mixed, after which butyl acetate was heated and removed under reduced pressure and then 0.05 part by weight of curing accelerator (1) was added, to prepare an isocyanate component solution P_{B}.

Separately, 10.6 parts by weight of polyol (A2) was added to 19.7 parts by weight of polyol (A1), and the mixture was heated and stirred to prepare a homogeneous polyol component solution A.

The polyol component solution A, 2.0 parts by weight of release agent (D2) and 2.0 parts by weight of dispersing agent (E2) were melt mixed to obtain solution D.

After mixing 69.8 parts by weight of the isocyanate component solution P_{B} and 19.4 parts by weight of solution D (hydroxyl equivalent/isocyanate group equivalent ratio: 1.0), the mixture was subjected to reduced-pressure defoaming to obtain a urethane resin composition for Comparative Example 7.

### Comparative Example 8

After adding 10.6 parts by weight of polyol (A2) to 19.7 parts by weight of polyol (A1), the mixture was heated and stirred to prepare a homogeneous polyol component solution A.

Separately, 1.0 part by weight of the polyol (A2) was added to 14.4 parts by weight of isocyanate (B1), and the mixture was reacted at 100° C. for 1 hour under a nitrogen atmosphere to prepare an isocyanate group-remaining prepolymer.

Also, 15.4 parts by weight of the isocyanate group-remaining prepolymer, 15.1 parts by weight of isocyanate (B2), 39.2 parts by weight of isocyanate (B3) and 0.1 part by weight of an antioxidant (C1) were mixed and then the butyl acetate was heated and removed under reduced pressure to prepare an isocyanate component solution P_{B}.

The isocyanate component solution P_{B}, 2.0 parts by weight of release agent (D2) and 10.0 parts by weight of dispersing agent (E2) were melt mixed, and then 0.05 part by weight of curing accelerator (1) was added to obtain solution C6.

After mixing 30.3 parts by weight of the polyol component solution A and 74.3 parts by weight of solution C6 (hydroxyl equivalent/isocyanate group equivalent ratio: 1.0), the mixture was subjected to reduced-pressure defoaming to obtain a urethane resin composition for Comparative Example 8.

### Comparative Example 9

After adding 10.6 parts by weight of polyol (A2) to 19.7 parts by weight of polyol (A 1), the mixture was heated and stirred to prepare a homogeneous polyol component solution A.

Separately, 1.0 part by weight of the polyol (A2) was added to 14.4 parts by weight of isocyanate (B1), and the mixture was reacted at 100° C. for 1 hour under a nitrogen atmosphere to prepare an isocyanate group-remaining prepolymer.

Also, 15.4 parts by weight of the isocyanate group-remaining prepolymer, 15.1 parts by weight of isocyanate (B2), 39.2 parts by weight of isocyanate (B3) and 0.1 part by weight of an antioxidant (C1) were mixed and then the butyl acetate was heated and removed under reduced pressure to prepare an isocyanate component solution P_{B}. The isocyanate component solution P_{B}, 2.0 parts by weight of release agent (D2) and 2.0 parts by weight of dispersing agent (E3) were melt mixed, and then 0.05 part by weight of curing accelerator (1) was added to obtain solution C7.

After mixing 30.3 parts by weight of the polyol component solution A and 74.3 parts by weight of solution C7 (hydroxyl equivalent/isocyanate group equivalent ratio: 1.0), the mixture was subjected to reduced-pressure defoaming to obtain a urethane resin composition for Comparative Example 9.

### Comparative Example 10

After adding 10.6 parts by weight of polyol (A2) to 19.7 parts by weight of polyol (A1), the mixture was heated and stirred to prepare a homogeneous polyol component solution A.

Separately, 1.0 part by weight of the polyol (A2) was added to 14.4 parts by weight of isocyanate (B1), and the mixture was reacted at 100° C. for 1 hour under a nitrogen atmosphere to prepare an isocyanate group-remaining prepolymer.

Also, 15.1 parts by weight of isocyanate (B2), 39.2 parts by weight of isocyanate (B3) and 0.1 part by weight of an antioxidant (C1) were added to 15.4 parts by weight of the isocyanate group-remaining prepolymer and mixed therewith, and then the butyl acetate was heated and removed under reduced pressure to prepare an isocyanate component solution P_{B}.

The isocyanate component solution P_{B}, 2.0 parts by weight of release agent (D3) and 2.0 parts by weight of dispersing agent (E2) were melt mixed, and then 0.05 part by weight of curing accelerator (1) was added to obtain solution C8.

After mixing 30.3 parts by weight of the polyol component solution A and 74.3 parts by weight of solution C8 (hydroxyl equivalent/isocyanate group equivalent ratio: 1.0), the mixture was subjected to reduced-pressure defoaming to obtain a urethane resin composition for Comparative Example 10.

[Evaluation]

The urethane resin compositions obtained in Examples 4-10 and Comparative Examples 6-10 were evaluated for gelling time, shear bonding strength, liquid transfer molding property and compatibility, by the methods described below. The obtained results are shown in Tables 2 to 4.

(Gelling Time)

The gelling time was determined using a gelling tester by SYSTEM SEIKO, setting the hot plate temperature to 165° C. and measuring the time until gelling of the urethane resin composition.

(Shear Bonding Strength (Shear Release Force))

A mock-up evaluation of die releasability was conducted by forming a cured product of the urethane resin composition on the die and measuring the peel strength. Also, as an extended evaluation of mold release, the aforementioned resin formation, and formation of a cured product of the urethane resin composition and measurement at the detachment points were repeated, and the strength was determined after repeating the procedure 5 times.

Specifically, a die piece with a fluorine-based coating was heated to 165° C., and a urethane resin composition droplet was dropped onto it to form a semi-spherical cured product with a radius of 1.5 mm. After 5 minutes from dropping, a DAYE Series 4000 by Arctec, Inc. was used for measurement of the shear bonding strength (shear release force) at a measuring temperature of 165° C. and a tool travelling speed of 100 μm/s.

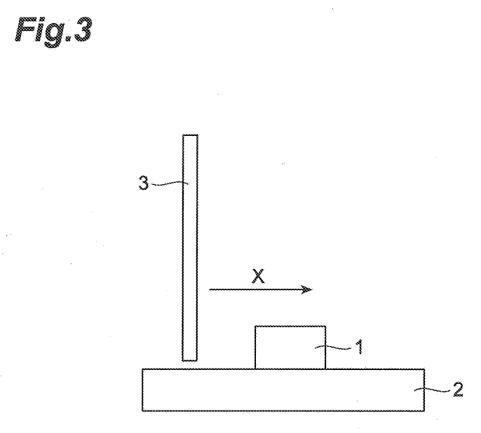

FIG. 3 is a schematic illustration of a measuring apparatus for the shear bonding strength. The cured product 1 of the urethane resin composition formed on a silver-plated copper sheet 2 (die piece) was pressed with a rod member (shear tool) 3, and the force X applied by the shear tool 3 when the cured product 1 peeled was recorded as the shear bonding strength (shear release force).

(Liquid Transfer Molding Property (Releasability))

The liquid transfer molding conditions were a mold temperature of 160-170° C., an injection pressure of 4 MPa-15 MPa, an injection time of 15-60 seconds and a retention time of 60-300 seconds. In this molding method, the urethane resin composition was molded into an LED package with outer dimensions of 5.1 mm×3.9 mm×4.7 mm, and the releasability was evaluated at the 10th shot. As the evaluation criteria, sticking of the resin to the cull, runner and cavity sections when the mold was opened, and attachment of the resin to the upper die or lower die was evaluated as (B), and lack of resin sticking, allowing easy removal from the die, was evaluated as (A).

(Transparency (Compatibility))

A liquid transfer molding machine was used for molding of a 40×40 mm test piece with a thickness of 1 mm at a mold temperature of 165° C. and a curing time of 20 seconds, and postcuring was carried out is at 150° C. for 3 hours. The light transmittance of the obtained test piece was measured at a wavelength of 460 nm using a U-3310 spectrophotometer by Hitachi, Ltd. In percentage units, those with 70% or greater were evaluated as (A), and those with up to 70% were evaluated as (B).

TABLE 2

| | | | | Example | | | | |
|---|---|---|---|---|---|---|---|---|
| | | | | 4 | 5 | 6 | 7 | 8 |
| Melt mixing | Polyisocyanate | Prepolymer | Polyol (A2) | 1.0 | 1.0 | 1.0 | — | — |
| components | (B) | | Isocyanate (B1) | 14.4 | 14.4 | 14.4 | — | — |
| | | | Isocyanate (B2) | 15.1 | 15.1 | 15.1 | 49.8 | — |
| | | | Isocyanate (B3) | 39.2 | 39.2 | 39.2 | — | — |
| | | | Isocyanate (B4) | — | — | — | — | 48.2 |

| | | | | | | | |
|---|---|---|---|---|---|---|---|
| | Release agent (D) | Release agent | 2.0 | — | 2.0 | 2.0 | 2.0 |
| | | (D1) | | | | | |
| | | Release agent | — | 2.0 | — | — | — |
| | | (D2) | | | | | |
| | Dispersing agent (E) | Dispersing | 2.0 | — | 2.0 | 2.0 | 2.0 |
| | | agent (E1) | | | | | |
| | | Dispersing | — | 2.0 | — | — | — |
| | | agent (E2) | | | | | |
| | Antioxidant (C) | Antioxidant | 0.10 | 0.10 | 0.10 | — | — |
| | | (C1) | | | | | |
| Mixing | Curing accelerator | Curing | 0.05 | 0.05 | — | 0.05 | 0.05 |
| components | | accelerator (1) | | | | | |
| | Polyol (A) | Polyol (A1) | 19.7 | 19.7 | 19.7 | 50.2 | 51.7 |
| | | Polyol (A2) | 10.6 | 10.6 | 10.6 | — | — |

| | | | | | | |
|---|---|---|---|---|---|---|
| Cured product properties | Gelling time (s) | 30 | 30 | 120 | 22 | 28 |
| | Compatibility | A | A | A | A | A |
| | Shear release | 0.04 | 0.05 | 0.08 | 0.07 | 0.07 |
| | force (Pa) | | | | | |
| | | A | A | A | A | A |

(Component mixing proportion units: parts by wt.)

TABLE 3

| | | | | Example | |
|---|---|---|---|---|---|
| | | | | 9 | 10 |
| Melt | Poly- | Pre- | Polyol (A2) | 1.0 | 1.0 |
| mixing | isocyanate | polymer | Isocyanate (B1) | 14.4 | 14.4 |
| components | (B) | | Isocyanate (B2) | 15.1 | 15.1 |
| | | | Isocyanate (B3) | 39.2 | 39.2 |
| | | | Isocyanate (B4) | — | — |

| | | | | |
|---|---|---|---|---|
| | Release agent (D) | Release agent | 2.0 | — |
| | | (D4) | | |
| | | Release agent | — | 2.0 |
| | | (D5) | | |
| | Dispersing agent (E) | Dispersing agent | 2.0 | 2.0 |
| | | (E1) | | |
| | | Dispersing agent | — | — |
| | | (E2) | | |
| | Antioxidant (C) | Antioxidant (C1) | 0.10 | 0.10 |
| Mixing | Curing accelerator | Curing accelerator | 0.05 | 0.05 |
| components | | (1) | | |
| | Polyol (A) | Polyol (A1) | 19.7 | 19.7 |
| | | Polyol (A2) | 10.6 | 10.6 |

| | | | |
|---|---|---|---|
| Cured product properties | Gelling time (s) | 30 | 30 |
| | Compatibility | A | A |
| | Shear release | 0.08 | 0.07 |
| | force (Pa) | | |
| | Releasability | A | A |

(Component mixing proportion units: parts by wt.)

TABLE 4

| | | | | Comp. Ex. | | | | |
|---|---|---|---|---|---|---|---|---|
| | | | | 6 | 7 | 8 | 9 | 10 |
| Melt mixing | Polyisocyanate | Prepolymer | Polyol (A2) | 1.0 | 1.0 | 1.0 | 1.0 | 1.0 |
| components | (B) | | Isocyanate | 14.4 | 14.4 | 14.4 | 14.4 | 14.4 |
| | | | (B1) | | | | | |
| | | | Isocyanate | 15.1 | 15.1 | 15.1 | 15.1 | 15.1 |
| | | | (B2) | | | | | |
| | | | Isocyanate | 39.2 | 39.2 | 39.2 | 39.2 | 39.2 |
| | | | (B3) | | | | | |
| | | | Isocyanate | — | — | — | — | — |
| | | | (B4) | | | | | |

| | | | | | | | |
|---|---|---|---|---|---|---|---|
| | Release agent (D) | Release agent | 2.0 | 2.0 | 2.0 | 2.0 | — |
| | | (D1) | | | | | |
| | | Release agent | — | — | — | — | — |
| | | (D2) | | | | | |
| | | Release agent | — | — | — | — | 2.0 |
| | | (D3) | | | | | |
| | Dispersing agent (E) | Dispersing | 2.0 | 2.0 | 10.0 | — | 2.0 |
| | | agent (E1) | | | | | |
| | | Dispersing | — | — | — | — | — |
| | | agent (E2) | | | | | |
| | | Dispersing | — | — | — | 2.0 | — |
| | | agent (E3) | | | | | |
| | Antioxidant (C) | Antioxidant | 0.10 | 0.10 | 0.10 | — | — |
| | | (C1) | | | | | |
| Mixing | Curing accelerator | Curing | 0.05 | 0.05 | 0.05 | 0.05 | 0.05 |
| components | | accelerator (1) | | | | | |
| | Polyol (A) | Polyol (A1) | 19.7 | 19.7 | 19.7 | 19.7 | 19.7 |
| | | Polyol (A2) | 10.6 | 10.6 | 10.6 | 10.6 | 10.6 |

| | | | | | | |
|---|---|---|---|---|---|---|
| Cured product properties | Gelling time (s) | 35 | 35 | 45 | 50 | 50 |
| | Compatibility | B | B | B | B | B |
| | Shear release | 0.65 | 0.58 | 0.07 | 0.35 | 1.45 |
| | force (Pa) | | | | | |
| | Releasability | B | B | A | B | A |

(Component mixing proportion units: parts by wt.)

“Study 3”

### Example 11

As the polyol component, a homogeneous polyol component was obtained by mixing 19.7 parts by weight of polycaprolactone triol with a molecular weight of 300 and a hydroxyl value of 540 (mg/gKOH) (A1: PLACCEL 303, by Daicel Chemical Industries, Ltd.), and 10.6 parts by weight of trimethylolpropane (A2: product of Perstorp), and heating and stirring the mixture. Next, 0.5 part by weight of γ-mercaptopropyltrimethoxysilane (F1: ICBM-803 by Shin-Etsu Chemical Co., Ltd.) was added as a silane coupling agent with a thiol group, and stirred therewith to prepare solution A.

Separately, 1.0 part by weight of trimethylolpropane (A2) and 14.4 parts by weight of 4,4′-methylenebis(cyclohexyl isocyanate) (B1: DESMODUR W by Sumika Bayer Urethane Co., Ltd.) were mixed and reacted at 100° C. for 1 hour under a nitrogen atmosphere to prepare an isocyanate group-remaining prepolymer.

As the polyisocyanate component there were mixed 15.4 parts by weight of the prepolymer, 15.1 parts by weight of norbornane diisocyanate (B2: COSMONATE NBDI by Mitsui Takeda Chemicals, Inc.), 39.2 parts by weight of a 70 wt % butyl acetate solution of isocyanurate-type isocyanate as an isophorone diisocyanate trimer (B3: VESTANAT (R)T1890 by Degussa), and 0.10 part by weight of 3,9-bis[2-{3-(3-tert-butyl-4-hydroxy-5-methylphenyl)propionyl}-1,1-dimethylethyl]-2,4,8,10-tetraoxaspiro[5,5]undecane as a hindered phenol-based antioxidant (C: SUMIRIZER GA-80 by Sumitomo Chemical Co., Ltd.), and then the butyl acetate was distilled off under reduced pressure to obtain solution P_{B}.

The solution P_{B}, and as release agents, 2.0 parts by weight of isostearic acid (D1: Isostearic Acid EX by Kokyu Alcohol Kogyo Co., Ltd. (a compound of formula (1) wherein R¹ is a C18 branched chain alkyl group)) and 2.0 parts by weight of polyether-modified silicone (E1: SLJ02 by Asahi Kasei Wacker Co., Ltd. (a compound of formula (3) with m/n=0.7 and weight-average molecular weight Mw=9,000)) were mixed and hot melted at 150° C. for 10 minutes, and stirred at room temperature to transparent homogeneity. Next, 0.05 part by weight of zinc stearate (NISSAN ELECTOL MZ-2 by NOF Corp.) was added as a curing accelerator, and the mixture was stirred to prepare solution B. After then mixing 14.3 parts by weight of solution A and 37.8 parts by weight of solution B (hydroxyl equivalent/isocyanate group equivalent ratio: 1.0), the mixture was subjected to reduced-pressure defoaming to obtain a urethane resin composition.

### Example 12

As the polyol component, a homogeneous polyol component was obtained by mixing 19.7 parts by weight of polycaprolactone triol (A1) and 10.6 parts by weight of trimethylolpropane (A2), and heating and stirring the mixture. Next, 0.5 part by weight of γ-mercaptopropylmethyldimethoxysilane (F2: KBM-802 by Shin-Etsu Chemical Co., Ltd.) was added as a silane coupling agent with a thiol group, and stirred therewith to prepare solution A.

Separately, 1.0 part by weight of trimethylolpropane (A2) and 14.4 parts by weight of 4,4′-methylenebis(cyclohexyl isocyanate) (B1) were mixed and reacted at 100° C. for 1 hour under a nitrogen atmosphere to prepare an isocyanate group-remaining prepolymer.

As the polyisocyanate component there were mixed 15.4 parts by weight of the prepolymer, 15.1 parts by weight of norbornane diisocyanate (B2), 39.2 parts by weight of a 70 wt % butyl acetate solution of isocyanurate-type isocyanate as an isophorone diisocyanate trimer (B3), and 0.10 part by weight of 3,9-bis[2-{3-(3-tert-butyl-4-hydroxy-5-methylphenyl)propionyl}-1,1-dimethylethyl]-2,4,8,10-tetraoxaspiro[5,5]undecane as a hindered phenol-based antioxidant (C), and then the butyl acetate was distilled off under reduced pressure to obtain solution P_{B}.

The solution P_{B}, and as a release agent, 2.0 parts by weight of lauric acid (D2: LUNAC L-98 by Kao Corp. (a compound of formula (1) wherein R¹ is a C11 straight-chain alkyl group)) and 2.0 parts by weight of polyether-modified silicone (E2: SLJ01 by Asahi Kasei Wacker Co., Ltd. (a compound of formula (3) with m/n=0.8 and Mw=6,000)) were melt mixed, hot melted at 150° C. for 10 minutes, and stirred at room temperature to transparent homogeneity. Next, 0.05 part by weight of zinc stearate was added as a curing accelerator, and the mixture was stirred to prepare solution B. After then mixing 30.3 parts by weight of solution A and 74.3 parts by weight of solution B (hydroxyl equivalent/isocyanate group equivalent ratio: 1.0), the mixture was subjected to reduced-pressure defoaming to obtain a urethane resin composition.

### Example 13

As the polyol component, a homogeneous polyol component was obtained by mixing 19.7 parts by weight of polycaprolactone triol (A1) and 10.6 parts by weight of trimethylolpropane (A2), and heating and stirring the mixture. Next, 0.5 part by weight of γ-mercaptopropyltrimethoxysilane (F1) was added as a silane coupling agent with a thiol group, and stirred therewith to prepare solution A. Separately, 1.0 part by weight of trimethylolpropane (A2) and 14.4 parts by weight of 4,4′-methylenebis(cyclohexyl isocyanate) (B1) were mixed and reacted at 100° C. for 1 hour under a nitrogen atmosphere to prepare an isocyanate group-remaining prepolymer.

As the polyisocyanate component there were mixed 15.4 parts by weight of the prepolymer, 15.1 parts by weight of norbornane diisocyanate (B2), 39.2 parts by weight of a 70 wt % butyl acetate solution of isocyanurate-type isocyanate as an isophorone diisocyanate trimer (B3), and 0.10 part by weight of 3,9-bis[2-{3-(3-tert-butyl-4-hydroxy-5-methylphenyl)propionyl}-1,1-dimethylethyl]-2,4,8,10-tetraoxaspiro[5,5]undecane as a hindered phenol-based antioxidant (C), and then the butyl acetate was distilled off under reduced pressure to obtain solution P_{B}.

Next, the solution P_{B}, and 0.05 part by weight of zinc stearate as a curing accelerator, were added and the mixture was stirred to prepare solution B. After then mixing 30.3 parts by weight of solution A and 74.3 parts by weight of solution B (hydroxyl equivalent/isocyanate group equivalent ratio: 1.0), the mixture was subjected to reduced-pressure defoaming to obtain a urethane resin composition.

### Example 14

Next, 50.2 parts by weight of polycaprolactone triol (A1) as a polyol component, and 0.5 part by weight of γ-mercaptopropyltrimethoxysilane (F1) as a silane coupling agent with a thiol group, were added and the mixture was stirred to prepare solution A.

This was followed by melt mixing of 49.8 parts by weight of norbornane diisocyanate (B2) and, as release agents, 2.0 parts by weight of isostearic acid (D1) and 2.0 parts by weight of polyether-modified silicone (E1), and the mixture was hot melted at 150° C. for 10 minutes and stirred at room temperature to transparent homogeneity.

Next, 0.05 part by weight of zinc stearate as a curing accelerator, and 0.5 part by weight of γ-mercaptopropyltrimethoxysilane (F1) as a silane coupling agent with a thiol group, were added and the mixture was stirred to prepare solution B. After then mixing 50.2 parts by weight of solution A and 53.8 parts by weight of solution B (hydroxyl equivalent/isocyanate group equivalent ratio: 1.0), the mixture was subjected to reduced-pressure defoaming to obtain a urethane resin composition.

### Example 15

As the polyol component there was used 51.7 parts by weight of polycaprolactone triol (A1). Next, 0.5 part by weight of γ-mercaptopropyltrimethoxysilane (F1) was added as a silane coupling agent with a thiol group, and stirred therewith to prepare solution A.

After melt mixing 48.2 parts by weight of an aliphatic primary diisocyanate (B4: TAKENATE 600 by Mitsui Chemical Polyurethane Co., Ltd.), and as release agents, 2.0 parts by weight of isostearic acid (D1) and 2.0 parts by weight of polyether-modified silicone (E1), the mixture was hot melted at 150° C. for 10 minutes and stirred at room temperature to transparent homogeneity. Next, 0.05 part by weight of zinc stearate was added as a curing accelerator, and the mixture was stirred to prepare solution B. After then mixing 51.7 parts by weight of solution A and 52.2 parts by weight of solution B (hydroxyl equivalent/isocyanate group equivalent ratio: 1.0), the mixture was subjected to reduced-pressure defoaming to obtain a urethane resin composition.

### Comparative Example 11

As the polyol component, a homogeneous polyol component was obtained by mixing 19.7 parts by weight of polycaprolactone triol (A1) and 10.6 parts by weight of trimethylolpropane (A2), and heating and stirring the mixture.

Separately, 1.0 part by weight of trimethylolpropane (A2) and 14.4 parts by weight of 4,4′-methylenebis(cyclohexyl isocyanate) (B1) were mixed and reacted at 100° C. for 1 hour under a nitrogen atmosphere to prepare an isocyanate group-remaining prepolymer.

As the polyisocyanate component there were mixed 15.4 parts by weight of the prepolymer, 15.1 parts by weight of norbornane diisocyanate (B2), 39.2 parts by weight of a 70 wt % butyl acetate solution of isocyanurate-type isocyanate as an isophorone diisocyanate trimer (B3), and 0.10 part by weight of 3,9-bis[2-{3-(3-tert-butyl-4-hydroxy-5-methylphenyl)propionyl}-1,1-dimethylethyl]-2,4,8,10-tetraoxaspiro[5,5]undecane as a hindered phenol-based antioxidant (C), and then the butyl acetate was distilled off under reduced pressure to obtain solution P_{B}.

This was followed by melt mixing of solution P_{B} and, as a release agent, 2.0 parts by weight of isostearic acid (D1) and 2.0 parts by weight of polyether-modified silicone (E1), and the mixture was hot melted at 150° C. for 10 minutes and stirred at room temperature to transparent homogeneity. Next, 0.05 part by weight of zinc stearate was added as a curing accelerator, and the mixture was stirred to prepare solution B. After then mixing 30.3 parts by weight of solution A and 74.3 parts by weight of solution B (hydroxyl equivalent/isocyanate group equivalent ratio: 1.0), the mixture was subjected to reduced-pressure defoaming to obtain a urethane resin composition.

### Comparative Example 12

As the polyol component, a homogeneous polyol component was obtained by mixing 19.7 parts by weight of polycaprolactone triol (A1) and 10.6 parts by weight of trimethylolpropane (A2), and heating and stirring the mixture. Next, 0.5 part by weight of 3-isocyanatepropyltriethoxysilane (F3: KBE-9007 by Shin-Etsu Chemical Co., Ltd.) was added as a silane coupling agent with a thiol group, and the mixture was stirred to prepare solution A. Separately, 1.0 part by weight of trimethylolpropane (A2) and 14.4 parts by weight of 4,4′-methylenebis(cyclohexyl isocyanate) (B1) were mixed and reacted at 100° C. for 1 hour under a nitrogen atmosphere to prepare an isocyanate group-remaining prepolymer.

As the polyisocyanate component there were mixed 15.4 parts by weight of the prepolymer, 15.1 parts by weight of norbornane diisocyanate (B2), 39.2 parts by weight of a 70 wt % butyl acetate solution of isocyanurate-type isocyanate as an isophorone diisocyanate trimer (B3), and 0.10 part by weight of 3,9-bis[2-{3-(3-tert-butyl-4-hydroxy-5-methylphenyl)propionyl}-1,1-dimethylethyl]-2,4,8,10-tetraoxaspiro[5,5]undecane as a hindered phenol-based antioxidant (C), and then the butyl acetate was distilled off under reduced pressure to obtain solution P_{B}.

This was followed by melt mixing of solution P_{B} and, as release agents, 2.0 parts by weight of isostearic acid (D1) and 2.0 parts by weight of polyether-modified silicone (E1), and the mixture was hot melted at 150° C. for 10 minutes and stirred at room temperature to transparent homogeneity. Next, 0.05 part by weight of zinc stearate was added as a curing accelerator, and the mixture was stirred to prepare solution B. After then mixing 30.3 parts by weight of solution A and 74.3 parts by weight of solution B (hydroxyl equivalent/isocyanate group equivalent ratio: 1.0), the mixture was subjected to reduced-pressure defoaming to obtain a urethane resin composition.

### Comparative Example 13

As the polyol component, a homogeneous polyol component was obtained by mixing 19.7 parts by weight of polycaprolactone triol (A1) 1.0 and 10.6 parts by weight of trimethylolpropane (A2), and heating and stirring the mixture. Next, 0.5 part by weight of 3-glycidoxypropyltrimethoxysilane (F4: KBM-403 by Shin-Etsu Chemical Co., Ltd.) was added, and stirred therewith to prepare solution A.

Separately, 1.0 part by weight of trimethylolpropane (A2) and 14.4 parts by weight of 4,4′-methylenebis(cyclohexyl isocyanate) (B1) were mixed and reacted at 100° C. for 1 hour under a nitrogen atmosphere to prepare an isocyanate group-remaining prepolymer.

As the polyisocyanate component there were mixed 15.4 parts by weight of the prepolymer, 15.1 parts by weight of norbornane diisocyanate (B2), 39.2 parts by weight of a 70 wt % butyl acetate solution of isocyanurate-type isocyanate as an isophorone diisocyanate trimer (B3), and 0.10 part by weight of 3,9-bis[2-{3-(3-tert-butyl-4-hydroxy-5-methylphenyl)propionyl}-1,1-dimethylethyl]-2,4,8,10-tetraoxaspiro[5,5]undecane as a hindered phenol-based antioxidant (C), and then the butyl acetate was distilled off under reduced pressure to obtain solution P_{B}.

This was followed by melt mixing of solution P_{B} and, as release agents, 2.0 parts by weight of isostearic acid (D1) and 2.0 parts by weight of polyether-modified silicone (E1), and the mixture was hot melted at 150° C. for 10 minutes and stirred at room temperature to transparent homogeneity. Next, 0.05 part by weight of zinc stearate was added as a curing accelerator, and the mixture was stirred to prepare solution B. After then mixing 30.3 parts by weight of solution A and 74.3 parts by weight of solution B (hydroxyl equivalent/isocyanate group equivalent ratio: 1.0), the mixture was subjected to reduced-pressure defoaming to obtain a urethane resin composition.

The urethane resin compositions obtained as described above were evaluated by the following methods.

### <Gelling Time>

The gelling time was measured using a gelling tester (product of System Seiko Co., Ltd.). The urethane resin composition was placed on a hot plate at 165° C., and the time (sec) until gelling of the urethane resin composition was measured, yielding the results shown in Tables 5 and 6.

<Compatibility>

A liquid transfer molding machine was used for molding of a 40×40 mm test piece with a thickness of 1 mm at a mold temperature of 165° C. and a time of 20 seconds, and then heat curing was carried out at 150° C. for 3 hours. The light transmittance of the obtained test piece was measured at a wavelength of 460 nm using a spectrophotometer (U-3310 by Hitachi, Ltd.). Test pieces with transmittance of at least 70% were evaluated as (A) and those with less than 70% were evaluated as (B), yielding the results shown in Tables 5 and 6.

<Bonding Strength>

A urethane resin composition droplet was dropped onto a silver-plated copper sheet and heated at 165° C. for 3 hours to form a cylindrical cured product with a radius of 1.5 mm. The shear bonding strength (MPa) of the cured object was measured using a bond tester (Dage Series 4000, product of Arctec, Inc.). Measurement was conducted with a measuring temperature of 165° C., a tool travelling speed of 100 μm/s, and movement of the shear tool 3 in the direction of X shown in FIG. 3, and the results shown in Tables 5 and 6 were obtained.

<Detachment after Molding/Detachment after Reflow>

A liquid transfer molding machine was used for molding at a mold temperature of 165° C., an injection pressure of 9.8 MPa, an injection time of 30 seconds and a curing time of 120 seconds, to form an LED package with outer dimensions of 5.1 mm×3.9 mm. The formed LED package was allowed to absorb moisture under conditions of 85° C., 85% RH for 9 hours, and then reflow treatment was carried out under a profile with a holding temperature of 150° C. for 120 seconds and a maximum ultimate temperature of 260° C. for 5 seconds.

The detachment between the cured object and lead frame in the LED package was observed with a microscope after molding and after reflow, yielding the results shown in Tables 5 and 6. The numerators in the table indicate the number of packages with detachment, and the denominators indicate the total number of packages evaluated under the same conditions.

TABLE 5

| | | | Example | | | | |
|---|---|---|---|---|---|---|---|
| | | | 11 | 12 | 13 | 14 | 15 |
| Solution A | Polyol | A1 | 19.7 | 19.7 | 19.7 | 50.2 | 51.7 |
| (Polyol | | A2 | 10.6 | 10.6 | 10.6 | — | — |
| component) | | | | | | | |
| Solution B | Isocyanate | A2 | 1.0 | 1.0 | 1.0 | — | — |
| (Polyisocyanate | group-remaining | B1 | 14.4 | 14.4 | 14.4 | — | — |
| components) | prepolymer | | | | | | |
| | Polyisocyanate | B2 | 15.1 | 15.1 | 15.1 | 49.8 | — |
| | | B3 | 39.2 | 39.2 | 39.2 | — | — |
| | | B4 | — | — | — | — | — |
| | Release agent | D1 | 2.0 | — | — | 2.0 | 2.0 |
| | | D2 | — | 2.0 | — | — | — |
| | | E1 | 2.0 | — | — | 2.0 | 2.0 |
| | | E2 | — | 2.0 | — | — | — |
| | Silane coupling agent | F1 | 0.5 | — | 0.5 | 0.5 | 0.5 |
| | with thiol group | F2 | — | 0.5 | — | — | — |
| | Antioxidant | C | 0.10 | 0.10 | 0.10 | — | — |
| | Curing accelerator | | 0.05 | 0.05 | 0.05 | 0.05 | 0.05 |
| Urethane resin | Gelling time | s | 30 | 30 | 20 | 22 | 28 |
| compositon | Compatibility | — | A | A | A | A | A |
| | Bonding strength | MPa | 22.5 | 21.1 | 34.1 | 20.4 | 19.3 |
| | Detachment after | — | 0/15 | 0/15 | 0/15 | 0/15 | 0/15 |
| | molding | | | | | | |
| | Detachment after | — | 0/15 | 0/15 | 0/15 | 0/15 | 0/15 |
| | reflow test | | | | | | |

TABLE 6

| | | | Comp. Ex. | | |
|---|---|---|---|---|---|
| | | | 11 | 12 | 13 |
| Solution A | Polyol | A1 | 19.7 | 19.7 | 19.7 |
| (Polyol | | A2 | 10.6 | 10.6 | 10.6 |
| component) | | | | | |
| Solution B | Isocyanate group- | A2 | 1.0 | 1.0 | 1.0 |
| (Polyisocyanate | remaining prepolymer | B1 | 14.4 | 14.4 | 14.4 |
| component) | Polyisocyanate | B2 | 15.1 | 15.1 | 15.1 |
| | | B3 | 39.2 | 39.2 | 39.2 |
| | Release agent | D1 | 2.0 | 2.0 | 2.0 |
| | | E1 | 2.0 | 10.0 | — |
| | Silane coupling agent | F1 | — | — | — |
| | with thiol group | F3 | — | 0.5 | — |
| | | F4 | — | — | 0.5 |
| | Antioxidant | C | 0.10 | 0.10 | 0.10 |
| | Curing accelerator | | 0.05 | 0.05 | 0.05 |
| Urethane resin | Gelling time | sec | 35 | 45 | 50 |
| composition | Compatibility | — | A | B | A |
| | Bonding strength | MPa | 4.3 | 2.5 | 3.1 |
| | Detachment after | — | 7/15 | 3/15 | 4/15 |
| | molding | | | | |
| | Detachment after | — | 9/15 | 5/15 | 6/15 |
| | reflow test | | | | |

“Study 4”

### Example 16

After mixing 40.9 parts by weight of polycaprolactone triol with a molecular weight of 300 and a hydroxyl value of 540 (mg/gKOH) (A2: PLACCEL 303 by Daicel Chemical Industries, Ltd.) as the polyol component, 0.5 part by weight of pentaerythritol tetrakis-3-mercaptopropionate (C1: PEMP by Sakai Chemical Industry Co., Ltd.) as a polythiol and 0.1 part by weight of [2-{3-(3-tert-butyl-4-hydroxy-5-methylphenyl)propionyl}-1,1-dimethylethyl]-2,4,8,10-tetraoxaspiro[5,5]undecane (F1: SUMIRIZER GA-80 by Sumitomo Chemical Co., Ltd.) as a hindered phenol-based antioxidant, the mixture was heated and stirred at 80° C. for 1 hour under a nitrogen atmosphere to obtain solution A containing a transparent homogeneous polyol component.

Separately, 4.5 parts by weight of trimethylolpropane (A1: product of Perstorp) and 54.6 parts by weight of isophorone diisocyanate (B1: VESTANAT IPDI by Degussa) were mixed and reacted at 80° C. for 6 hours under a nitrogen atmosphere to prepare an isocyanate group-remaining prepolymer, which was used as solution B containing an isocyanate component.

Next, 41 parts by weight of solution A and 59.2 parts by weight of solution B were mixed and stirred at room temperature to transparent homogeneity, to obtain a urethane resin composition.

### Example 17

A urethane resin composition was obtained in the same manner as Example 16, except that 0.5 part by weight of 2,2′-dimercaptodiethyl sulfide (C2: DMDES by Toyokasei Co., Ltd.) was added instead of (C1) as the polythiol.

### Example 18

After mixing 9.1 parts by weight of trimethylolpropane (A1), 18.1 parts by weight of polycaprolactone triol (A2) as the polyol component and 0.5 part by weight of pentaerythritol tetrakis-3-mercaptopropionate (C1) as a polythiol, the mixture was heated and stirred at 80° C. for 1 hour under a nitrogen atmosphere to obtain solution A containing a transparent homogeneous polyol component.

Separately, 0.5 part by weight of trimethylolpropane (A1) and 7.6 parts by weight of 4,4′-methylenebis-(cyclohexyl isocyanate) (B2: H12MDI by Degussa) were heated and stirred at 80° C. for 10 hours under a nitrogen atmosphere to obtain an isocyanate group-remaining prepolymer.

As the polyisocyanate component there were mixed 8.1 parts by weight of the isocyanate group-remaining prepolymer, 7.6 parts by weight of 4,4′-methylenebis-(cyclohexyl isocyanate) (B2), 15.9 parts by weight of norbornane diisocyanate (B3: COSMONATE NBDI by Mitsui Takeda Chemicals, Inc.), 41.2 parts by weight of a 70 wt % butyl acetate solution of isocyanurate-type polyisocyanate as an isophorone diisocyanate trimer (B4: DESMODUR Z4470BA by Sumika Bayer Urethane Co., Ltd.) and 0.1 part by weight of [2-{3-(3-tert-butyl-4-hydroxy-5-methylphenyl)propionyl}-1,1-dimethylethyl]-2,4,8,10-tetraoxaspiro[5,5]undecane as a hindered phenol-based antioxidant (F1), and then the butyl acetate was heated and removed under reduced pressure. Separately, as a release agent, 1.25 parts by weight of isostearic acid (E1: Isostearic Acid EX by Kokyu Alcohol Kogyo Co., Ltd.) and 1.25 parts by weight of a silicone-caprolactone copolymer (E2: Devp. No. SLJ-02 by Wacker Asahi Kasei Silicone Co., Ltd. (a compound of formula (3) with m/n=0.7 and weight-average molecular weight Mw=9,000)) were melt mixed at 150° C. for 10 minutes. Next, a release agent was added to the polyisocyanate component and the mixture was stirred to homogeneity. After then adding 0.1 part by weight of zinc stearate (D1: MZ-2 by NOF Corp.) as a curing catalyst, the mixture was stirred to homogeneity to prepare solution B containing an isocyanate component. Next, 27.1 parts by weight of solution A and 63.01 parts by weight of solution B were mixed and stirred at room temperature to homogeneity, to obtain a urethane resin composition.

### Example 19

A urethane resin composition was obtained in the same manner as Example 18, except that 0.5 part by weight of trimethylolpropane tris(3-mercaptopropionate) (C3: TMMP by Sakai Chemical Industry Co., Ltd.) was used instead of (C1) as the polythiol.

### Example 20

A urethane resin composition was obtained in the same manner as Example 18, except that 0.5 part by weight of tris-[(3-mercaptopropionyloxy)-ethyl]-isocyanurate (C4: TEMPICO by Sakai Chemical Industry Co., Ltd.) was used instead of (C1) as the polythiol.

### Example 21

A urethane resin composition was obtained in the same manner as Example 18, except that 0.5 part by weight of 2,2′-dimercaptodiethyl sulfide (C2: DMME by Toyokasei Co., Ltd.) was used instead of (C1) as the polythiol.

### Comparative Example 14

A urethane resin composition was obtained in the same manner as Example 16, except that no polythiol was added.

### Comparative Example 15

A urethane resin composition was obtained in the same manner as Example 18, except that no polythiol was added.

### Comparative Example 16

A urethane resin composition was obtained in the same manner as Example 18, except that 0.5 part by weight of 2-ethylhexyl-(3-mercaptopropionate) with only one thiol group (C5: product of Maruzen Petrochemical Co., Ltd.) was used instead of (C1) as the polythiol.

The amounts of each of the materials used in Examples 16-21 and Comparative Examples 14-16 are shown in Table 7 below.

TABLE 7

| | | Example | | | | | | Comp. Ex. | | |
|---|---|---|---|---|---|---|---|---|---|---|
| | | 16 | 17 | 18 | 19 | 20 | 21 | 14 | 15 | 16 |
| Polyol | A1 | — | — | 9.1 | 9.1 | 9.1 | 9.1 | — | 9.1 | 9.1 |
| | A2 | 40.9 | 40.9 | 18.1 | 18.1 | 18.1 | 18.1 | 40.9 | 18.1 | 18.1 |
| Isocyanate | A1 | 4.5 | 4.5 | 0.5 | 0.5 | 0.5 | 0.5 | 4.5 | 0.5 | 0.5 |
| group- | B1 | 54.6 | 54.6 | — | — | — | — | 54.6 | — | — |
| remaining | B2 | — | — | 7.6 | 7.6 | 7.6 | 7.6 | — | 7.6 | 7.6 |
| prepolymer | | | | | | | | | | |
| Polyisocyanate | B2 | — | — | 7.6 | 7.6 | 7.6 | 7.6 | — | 7.6 | 7.6 |
| | B3 | — | — | 15.9 | 15.9 | 15.9 | 15.9 | — | 15.9 | 15.9 |
| | B4 | — | — | 41.2 | 41.2 | 41.2 | 41.2 | — | 41.2 | 41.2 |
| Compound with | C1 | 0.5 | — | 0.5 | — | — | — | — | — | — |
| thiol group | C2 | — | 0.5 | — | — | — | 0.5 | — | — | — |
| | C3 | — | — | — | 0.5 | — | — | — | — | — |
| | C4 | — | — | — | — | 0.5 | — | — | — | — |
| | C5 | — | — | — | — | — | — | — | — | 0.5 |
| Curing catalyst | D1 | — | — | 0.1 | 0.1 | 0.1 | 0.1 | — | 0.1 | 0.1 |
| Release agent | E1 | — | — | 1.25 | 1.25 | 1.25 | 1.25 | — | 1.25 | 1.25 |
| | E2 | — | — | 1.25 | 1.25 | 1.25 | 1.25 | — | 1.25 | 1.25 |
| Antioxidant | F1 | 0.1 | 0.1 | 0.1 | 0.1 | 0.1 | 0.1 | 0.1 | 0.1 | 0.1 |

The urethane resin compositions obtained as described above were evaluated by the following methods.

### <Bonding Strength>

Each of the urethane resin compositions obtained in the examples and comparative examples was used to form a cylindrical cured object with a radius of 1.5 mm on a silver-plated copper sheet by a potting method, and was heated at 150° C. for 3 hours to produce a bonding test piece sample. The bonding strength between the test piece and the silver plating was measured using a bond tester (Dage Series 4000, product of Arctec, Inc.). The measuring temperature was room temperature, the tool travelling speed in FIG. 3 was 100 μm/s, the shear tool 3 was moved in the direction of X, and the shear bonding strength was measured. This is shown as the bonding strength in Table 8.

<Detachment after Molding/Detachment after Reflow>

Each of the urethane resin compositions of the examples and comparative examples was molded using a liquid transfer molding machine at a mold temperature of 165° C., an injection pressure of 9.8 MPa, an injection time of 30 seconds and a curing time of 120 seconds, to form an LED package with outer dimensions of 5.1 mm×3.9 mm. The obtained LED package was allowed to absorb moisture under conditions of 85° C., 85% RH for 9 hours, and then reflow treatment was carried out under a profile with a holding temperature of 150° C. for 120 seconds and a maximum ultimate temperature of 260° C. for 5 seconds.

The detachment between the sealing member and lead frame in the LED package was observed with a microscope after molding and after reflow, yielding the results shown in Table 8. The numerators in the table indicate the number of packages with detachment, and the denominators indicate the total number of packages evaluated under the same conditions.

TABLE 8

| | | Example | | | | | | Comp. Ex. | | |
|---|---|---|---|---|---|---|---|---|---|---|
| | | 16 | 17 | 18 | 19 | 20 | 21 | 14 | 15 | 16 |
| Bonding | MPa | 38 | 35 | 25 | 20 | 21 | 24 | 18 | 4 | 10 |
| strength | | | | | | | | | | |
| Detachment | — | 0/15 | 0/15 | 0/15 | 0/15 | 0/15 | 0/15 | 0/15 | 15/15 | 0/15 |
| after molding | | | | | | | | | | |
| Detachment | — | 0/15 | 0/15 | 0/15 | 0/15 | 0/15 | 0/15 | 2/15 | 15/15 | 2/15 |
| after reflow | | | | | | | | | | |

In Example 16, which included a compound with 2 or more thiol groups (polythiol) in the urethane resin composition and Example 17, which included a compound with 2 or more thiol groups and a sulfide group, the bonding strength with the silver plating was high, and no detachment was seen between the sealing member and lead frame after package molding and after reflow. The urethane resin compositions of Examples 18-21 contain a release agent, and further contain a compound with 2 or more thiol groups. The cured objects obtained from these urethane resin compositions had high bonding strength with the silver plating, and no detachment between the sealing member and lead frame after package molding and after reflow.

On the other hand, when no compound with 2 or more thiol groups was included, as in Comparative Examples 14 and 15, detachment was observed between the sealing member and lead frame. Detachment between the sealing member and lead frame was also observed even when a compound with one thiol group was included, as in Comparative Example 16.

“Study 5”

### Example 22

To 1 mol of trimethylolpropane (A2: product of Perstorp, molecular weight: 134, hydroxyl value: 1260 mgKOH/g) there was added 1 mol of propylene oxide to prepare 64.05 parts by weight of a polyol (A4) with a molecular weight of 192 and a hydroxyl value of 880 mgKOH/g, as the polyol component, to obtain polyol component solution A. Separately, 111.00 parts by weight of isophorone diisocyanate (C1: VESTANAT IPDI, trade name of Degussa) and 0.18 part by weight of [2-{3-(3-tert-butyl-4-hydroxy-5-methylphenyl)propionyl}-1,1-dimethylethyl]-2,4,8,10-tetraoxaspiro[5,5]undecane (G: SUMIRIZER GA-80, trade name of Sumitomo Chemical Co., Ltd.) as a hindered phenol-based antioxidant were mixed, to obtain solution B containing an isocyanate component. Next, 64.05 parts by weight of solution A and 111.18 parts by weight of solution B were mixed and stirred at room temperature to homogeneity, to obtain a urethane resin composition.

### Example 23

To 1 mol of trimethylolpropane (A2) there was added 1 mol of propylene oxide to prepare 51.24 parts by weight of a polyol (A4) with a molecular weight of 192 and a hydroxyl value of 880 mgKOH/g, as the polyol component, to obtain polyol component solution A. Separately, 8.93 parts by weight of trimethylolpropane (A2) and 111.00 parts by weight of isophorone diisocyanate (C1) were heated and stirred at 80° C. for 10 hours under a nitrogen atmosphere to obtain an isocyanate group-remaining prepolymer (B1). Also, 0.17 part by weight of [2-{3-(3-tert-butyl-4-hydroxy-5-methylphenyl)propionyl}-1,1-dimethylethyl]-2,4,8,10-tetraoxaspiro[5,5]undecane (G), as a hindered phenol-based antioxidant, was mixed therewith to obtain solution B containing an isocyanate component. Next, 51.24 parts by weight of solution A and 120.10 parts by weight of solution B were mixed and stirred at room temperature to homogeneity, to obtain a urethane resin composition.

### Example 24

To 1 mol of trimethylolpropane (A2) there was added 1 mol of propylene oxide to prepare 61.81 parts by weight of a polyol (A4) with a molecular weight of 192 and hydroxyl value of 880 mgKOH/g, as a polyol component, and there was further added 1.06 parts by weight of γ-mercaptopropyltrimethoxysilane (D: KBM-803, trade name of Shin-Etsu Chemical Co., Ltd.) as an adhesion-imparting agent, and the mixture was stirred to homogeneity to obtain a polyol component solution A.

Separately, 1.56 parts by weight of trimethylolpropane (A2) and 22.93 parts by weight of 4,4′-methylenebis-(cyclohexyl isocyanate) (C2: H12MDI, trade name of Degussa) were mixed, and the mixture was heated and stirred at 80° C. for 10 hours under a nitrogen atmosphere to obtain an isocyanate group-remaining prepolymer (B2).

As the polyisocyanate component there were mixed 24.49 parts by weight of the isocyanate group-remaining prepolymer (B2), 22.93 parts by weight of 4,4′-methylenebis-(cyclohexyl isocyanate) (C2), 41.8 parts by weight of norbornane diisocyanate (C3: COSMONATE NBDI, trade name of Mitsui Takeda Chemicals, Inc.), 82.00 parts by weight of a 75 wt % butyl acetate solution of isocyanurate-type polyisocyanate as an isophorone diisocyanate trimer (C4: Vestanat T1890 ME, trade name of Degussa) and 0.21 part by weight of [2-{3-(3-tert-butyl-4-hydroxy-5-methylphenyl)propionyl}-1,1-dimethylethyl]-2,4,8,10-tetraoxaspiro[5,5]undecane as a hindered phenol-based antioxidant (G), and then the butyl acetate was heated, and removed under reduced pressure. Separately, as a release agent, 5.33 parts by weight of isostearic acid (F1: Isostearic Acid EX, trade name of Kokyu Alcohol Kogyo Co., Ltd.) and 1.07 parts by weight of a silicone-caprolactone block copolymer (F2) were added to a polyisocyanate component, and the components were heated and mixed at 80° C. for 2 hours. The silicone-caprolactone block copolymer (F2) was produced by adding 22 mol of caprolactone to 1 mol of a both-terminal polyether-modified silicone (X-22-4952, trade name of Shin-Etsu Chemical Co., Ltd.), and it was a compound of formula (3) with m/n=0.6, weight-average molecular weight Mw=4,000. After cooling to room temperature, 0.11 part by weight of zinc stearate (E: MZ-2, trade name of NOF Corp.) was added as a curing catalyst, and the mixture was stirred to homogeneity to prepare solution B containing an isocyanate component. Next, 62.87 parts by weight of solution A and 157.44 parts by weight of solution B were mixed and stirred at room temperature to homogeneity, to obtain a urethane resin composition.

### Example 25

A urethane resin composition was obtained in the same manner as Example 24, except that a polyol component was produced by adding 1 mol of ethylene oxide to 1 mol of trimethylolpropane (A2) to obtain 57.73 parts by weight of polyol (A5) having a molecular weight of 179 and a hydroxyl value of 940 mgKOH/g, instead of the polyol (A4) of Example 24, and (A5) was used.

### Example 26

A urethane resin composition was obtained in the same manner as Example 24, except that the release agent of Example 24 was changed to 8.53 parts by weight of isostearic acid (F1) as the polyisocyanate component, and the silicone-caprolactone block copolymer (F2) was omitted.

### Example 27

A urethane resin composition was obtained in the same manner as Example 24, except that the polyol component used was 55.40 parts by weight of polyol (A4) and 10.43 parts by weight of polycaprolactone triol with a molecular weight of 300 and a hydroxyl value of 540 mgKOH/g (A3: PLACCEL 303, trade name of Daicel Chemical Industries, Ltd., molecular weight: 313, hydroxyl value: 540 mgKOH/g), stirred to homogeneity, instead of the polyol (A4) of Example 24.

### Comparative Example 17

A urethane resin composition was obtained in the same manner as Example 22, except that the polyol component used was 30.64 parts by weight of propane-1,2,3-triol (A1: Purified Glycerin, trade name of Sakamoto Yakuhin Kogyo Co., Ltd., molecular weight: 92, hydroxyl value: 1830 mgKOH/g) and 62.57 parts by weight of polycaprolactone triol (A3), stirred to homogeneity.

### Comparative Example 18

A urethane resin composition was obtained in the same manner as Example 24, except that the polyol component used was 29.92 parts by weight of trimethylolpropane (A2) and 31.28 parts by weight of polycaprolactone triol (A3), heated and stirred at 80° C. for 2 hours as a homogeneous polyol component.

### Comparative Example 19

A urethane resin composition was obtained in the same manner as Example 24, except that the polyol component used was 5.06 parts by weight of propane-1,2,3-triol (A1) and 83.42 parts by weight of polycaprolactone triol (A3), stirred to homogeneity.

The amounts of each of the materials used in Examples 22-27 and Comparative Examples 17-19 are shown in Table 9 below.

TABLE 9

| | | Example | | | | | | Comp. Ex. | | |
|---|---|---|---|---|---|---|---|---|---|---|
| | | 22 | 23 | 24 | 25 | 26 | 27 | 17 | 18 | 19 |
| Polyol | A1 | — | — | — | — | — | — | 30.64 | — | 5.06 |
| component | A2 | — | — | — | — | — | — | — | 29.92 | — |
| | A3 | — | — | — | — | — | 10.43 | 62.57 | 31.28 | 83.42 |
| | A4 | 64.05 | 51.24 | 61.81 | — | 61.81 | 55.4 | — | — | — |
| | A5 | — | — | — | 57.73 | — | — | — | — | — |
| Isocyanate | B1 | — | 119.93 | — | — | — | — | — | — | — |
| group- | B2 | — | — | 24.49 | 24.49 | 24.49 | 24.49 | — | 24.49 | 24.49 |
| remaining | | | | | | | | | | |
| prepolymer | | | | | | | | | | |
| Polyisocyanate | C1 | 111.00 | — | — | — | — | — | 111 | — | — |
| component | C2 | — | — | 22.93 | 22.93 | 22.93 | 22.93 | — | 22.93 | 22.93 |
| | C3 | — | — | 41.8 | 41.8 | 41.8 | 41.8 | — | 41.8 | 41.8 |
| | C4 | — | — | 82 | 82 | 82 | 82 | — | 82 | 82 |
| Adhesion- | D | — | — | 1.06 | 1.06 | 1.06 | 1.06 | — | 1.06 | 1.06 |
| imparting | | | | | | | | | | |
| agent | | | | | | | | | | |
| Curing catalyst | E | — | — | 0.11 | 0.11 | 0.11 | 0.11 | — | 0.11 | 0.11 |
| Release agent | F1 | — | — | 5.33 | 5.33 | 8.53 | 5.33 | — | 5.33 | 5.33 |
| | F2 | — | — | 1.07 | 1.07 | — | — | — | 1.07 | 1.07 |
| Antioxidant | G | 0.18 | 0.17 | 0.21 | 0.21 | 0.21 | 0.21 | 0.18 | 0.21 | 0.21 |

The urethane resin compositions obtained as described above were evaluated by the following methods.

### <Fabrication of Photosemiconductor Packages>

Each of the urethane resin compositions obtained in Examples 22 and 23 and Comparative Example 17 was packed by a potting method into the cavity of a light emitting element-mounted ceramic surface mount package having an outer shape of 5 mm×5 mm×1 mm and a cavity diameter of 4 mm, and heated and cured at 100° C. for 1 hour, at 125° C. for 1 hour and at 150° C. for 4 hours, to fabricate photosemiconductor devices. Also, each of the urethane resin compositions obtained in Examples 24-27 and Comparative Examples 18-19 was molded using a liquid transfer molding machine with a mold temperature of 165° C., an injection pressure of 9.8 MPa, an injection time of 30 seconds and a curing time of 120 seconds, and then subjected to postcuring in an oven at 150° C. for 4 hours, to fabricate a photosemiconductor package as shown in FIG. 2. The sealed section of the fabricated photosemiconductor package was observed with a microscope, and the homogeneity of the cured section, i.e. the presence of fluctuations or air bubbles, was examined. The results are shown in Table 10.

### <Measurement of Hardness and Glass Transition Temperature>

The hardness of the cured urethane resin composition was measured as the Shore hardness D, and the glass transition temperature was measured with a thermomechanical analyzer. The results are shown in Table 10.

TABLE 10

| | | Example | | | | | | Comp. Ex. | | |
|---|---|---|---|---|---|---|---|---|---|---|
| | | 22 | 23 | 24 | 25 | 26 | 27 | 17 | 18 | 19 |
| Hardness of cured | — | 75 | 76 | 85 | 84 | 85 | 84 | — | 84 | 83 |
| object | | | | | | | | | | |
| Glass transition | ° C. | 121 | 123 | 134 | 130 | 132 | 131 | — | 84 | 83 |
| temperature | | | | | | | | | | |
| Homogeneity of | — | A | A | A | A | A | A | B | B | B |
| cured object | | | | | | | | | | |
| Air bubbles in cured | — | A | A | A | A | A | A | — | B | B |
| object | | | | | | | | | | |

Table 10 shows the homogeneity of the cured objects, with A indicating homogeneous, and B indicating fluctuation in transparency. For air bubbles in the cured object, A indicates absence of air bubbles, and B indicates presence of air bubbles.

In Examples 22-27, all of the obtained cured objects were hard and had glass transition temperatures of 120° C. or higher, while the cured object transparency was homogeneous with no defects such as air bubbles. In Comparative Example 17, on the other hand, sufficient compatibility between solution A and solution B was not obtained, and a homogeneous cured object could not be obtained. Also, in Comparative Examples 18 and 19, the obtained cured objects were hard with glass transition temperatures of 83-84° C., but fluctuations and air bubbles were seen in the cured objects.

“Study 6”

### Example 28

After adding 10.6 parts by weight of trimethylolpropane (A2: product of Perstorp) and 0.5 part by weight of γ-mercaptopropyltrimethoxysilane (D1: KBM-803, trade name of Shin-Etsu Chemical Co., Ltd.) to 19.7 parts by weight of polycaprolactone triol with a molecular weight of 300 and a hydroxyl value of 540 (KOH·mg/g) (polyol A1: PLACCEL 303, trade name of Daicel Chemical Industries, Ltd.), the mixture was heated and stirred to produce a homogeneous polyol component A-1 solution, as the polyol component. Separately, 1.0 part by weight of (A2) was added to 14.4 parts by weight of 4-4′methylenebis(cyclohexyl isocyanate) (B1: DESMODUR W, trade name of Sumika Bayer Urethane Co., Ltd.), and the mixture was reacted at 80° C. for 10 hours under a nitrogen atmosphere to prepare an isocyanate group-remaining prepolymer solution P_{B}.

As the isocyanate component there were mixed 15.4 parts by weight of the prepolymer solution P_{B}, 15.1 parts by weight of norbornane diisocyanate (B2: COSMONATE NBDI, trade name of Mitsui Takeda Chemicals, Inc.), 39.2 parts by weight of a 70 wt % butyl acetate solution of isocyanurate-type isocyanate as an isophorone diisocyanate trimer (B3: VESTANAT (R)T1890, trade name of Degussa), and 0.10 part by weight of 3,9-bis[2-{3-(3-tert-butyl-4-hydroxy-5-methylphenyl)propionyl}-1,1-dimethylethyl]-2,4,8,10-tetraoxaspiro[5,5]undecane as a hindered phenol-based antioxidant, and then the butyl acetate was heated and removed under reduced pressure.

Next, as a release agent C1, 2.0 parts by weight of isostearic acid (a saturated fatty acid of formula (1) wherein R¹ is a C18 branched chain alkyl group, Isostearic Acid EX, trade name of Kokyu Alcohol Kogyo Co., Ltd.) and 2.0 parts by weight of a polyether-modified silicone-caprolactone block copolymer 1, obtained by ring-opening addition of polycaprolactone at both ends of a polyether-modified silicone oil (X-22-4952, trade name of Shin-Etsu Chemical Co., Ltd.), wherein m/n=0.5, were heated at 80° C. for 2 hours. After cooling to room temperature, 0.05 part by weight of zinc stearate (NISSAN ELECTOL MZ-2, trade name of NOF Corp.) was added as a curing accelerator, and the mixture was stirred to homogeneity. This was designated as solution B-1. After then mixing 14.3 parts by weight of solution A-1 and 37.8 parts by weight of solution B-1 (hydroxyl equivalent/isocyanate group equivalent ratio: 1.0), the mixture was subjected to reduced-pressure defoaming to obtain a urethane resin composition, which was evaluated.

### Example 29

As a polyol component, 10.6 parts by weight of (A2) and 0.5 part by weight of pentaerythritoltetrakis-3-mercapto propionate (D2: PEMP, trade name of Sakai Chemical Industry Co., Ltd.) were added to 19.7 parts by weight of (A1), and the mixture was heated and stirred to obtain a homogeneous polyol component solution A-2. Separately, 1.0 part by weight of (A2) was added to 14.4 parts by weight of (B1), and the mixture was reacted at 100° C. for 1 hour under a nitrogen atmosphere to prepare an isocyanate group-remaining prepolymer solution P_{B}. Also, as an isocyanate component, 15.1 parts by weight of (B2), 39.2 parts by weight of (B3) and 0.1 part by weight of the antioxidant were mixed with 15.4 parts by weight of the prepolymer solution P_{B}, and then the butyl acetate was heated and removed under reduced pressure. Next, 2.0 parts by weight of lauric acid (a saturated fatty acid of formula (1) wherein R¹ is a C11 straight-chain alkyl group, LUNAC L-98, trade name of Kao Corp.) as a release agent C2 and 2.0 parts by weight of a polyether-modified silicone-caprolactone block copolymer 2, obtained by ring-opening addition of polycaprolactone at both ends of a polyether-modified silicone oil (X-22-4952, trade name of Shin-Etsu Chemical Co., Ltd.), wherein m/n=0.6, were heated at 80° C. for 2 hours. Next, 0.05 part by weight of zinc stearate was added as a curing accelerator, and the mixture was stirred to prepare solution B-2. After then mixing 30.3 parts by weight of solution A-2 and 74.3 parts by weight of solution B-2 (hydroxyl equivalent/isocyanate group equivalent ratio: 1.0), the mixture was subjected to reduced-pressure defoaming to obtain a urethane resin composition, which was evaluated.

### Example 30

As a polyol component, 10.6 parts by weight of (A2) and 0.5 part by weight of trimethylolpropane tris-3-mercaptopropionate (D3: TMMP, trade name of Sakai Chemical Industry Co., Ltd.) were added to 19.7 parts by weight of (A1), and the mixture was heated and stirred to obtain a homogeneous polyol component solution A-3. Separately, 1.0 part by weight of (A2) was added to 14.4 parts by weight of (B1), and the mixture was reacted at 100° C. for 1 hour under a nitrogen atmosphere to prepare an isocyanate group-remaining prepolymer solution P_{B}. Also, as an isocyanate component, 15.1 parts by weight of (B2), 39.2 parts by weight of (B3) and 0.1 part by weight of the antioxidant were mixed with 15.4 parts by weight of the prepolymer solution P_{B}, and then the butyl acetate was heated and removed under reduced pressure. Next, as a release agent C1, 1.0 part by weight of isostearic acid and 1.0 part by weight of a polyether-modified silicone-caprolactone block copolymer 3, obtained by ring-opening addition of polycaprolactone at both ends of a polyether-modified silicone oil (X-22-4272, trade name of Shin-Etsu Chemical Co., Ltd.), wherein m/n=0.5, were heated at 80° C. for 2 hours. Next, 0.05 part by weight of zinc stearate was added, to prepare solution B-3. After then mixing 30.3 parts by weight of solution A-3 and 74.3 parts by weight of solution B-3 (hydroxyl equivalent/isocyanate group equivalent ratio: 1.0), the mixture was subjected to reduced-pressure defoaming to obtain a urethane resin composition, which was evaluated.

### Example 31

Using 48.2 parts by weight of (B2) as an isocyanate component B, there were added 51.7 parts by weight of (A1) and 0.5 part by weight of (D1), and the mixture was stirred to prepare polyol component solution A-4. The solution B and, as a release agent C1, 2.0 parts by weight of isostearic acid and 2.0 parts by weight of polyether-modified silicone-caprolactone block copolymer 1, were heated at 80° C. for 2 hours. Next, 0.05 part by weight of zinc stearate was added as a curing accelerator, and the mixture was stirred to prepare solution B-4. After then mixing 50.2 parts by weight of solution A-4 and 53.8 parts by weight of solution B-4 (hydroxyl equivalent/isocyanate group equivalent ratio: 1.0), the mixture was subjected to reduced-pressure defoaming to obtain a urethane resin composition, which was evaluated.

### Comparative Example 20

As a polyol component, 10.6 parts by weight of (A2) and 0.5 part by weight of (D1) were added to 19.7 parts by weight of (A1), and the mixture was heated and stirred to prepare a homogeneous polyol component solution A-5. Separately, 1.0 part by weight of (A2) was added to 14.4 parts by weight of (B1), and the mixture was reacted at 100° C. for 1 hour under a nitrogen atmosphere to prepare an isocyanate group-remaining prepolymer solution P_{B}. Also, as an isocyanate component, 15.1 parts by weight of (B2), 39.2 parts by weight of (B3) and 0.1 part by weight of the antioxidant were mixed with 15.4 parts by weight of the prepolymer solution P_{B}, and then the butyl acetate was heated and removed under reduced pressure. Next, as a release agent C1, 2.0 parts by weight of isostearic acid and 2.0 parts by weight of a polyether-modified silicone-caprolactone block copolymer 4, obtained by ring-opening addition of polycaprolactone at both ends of a polyether-modified silicone oil (X-22-4952, trade name of Shin-Etsu Chemical Co., Ltd.), wherein m/n=0.3, were heated at 80° C. for 2 hours. Next, 0.05 part by weight of zinc stearate was added, to prepare solution B-5. After then mixing 30.3 parts by weight of solution A-5 and 74.3 parts by weight of solution B-5 (hydroxyl equivalent/isocyanate group equivalent ratio: 1.0), the mixture was subjected to reduced-pressure defoaming to obtain a urethane resin composition, which was evaluated.

### Comparative Example 21

As a polyol component, 10.6 parts by weight of (A2) and 0.5 part by weight of (D2) were added to 19.7 parts by weight of (A1), and the mixture was heated and stirred to prepare a homogeneous polyol component solution A-6. Separately, 1.0 part by weight of (A2) was added to 14.4 parts by weight of (B1), and the mixture was reacted at 100° C. for 1 hour under a nitrogen atmosphere to prepare an isocyanate group-remaining prepolymer solution P_{B}. Also, as an isocyanate component, 15.1 parts by weight of (B2), 39.2 parts by weight of (B3) and 0.1 part by weight of the antioxidant were mixed with 15.4 parts by weight of the prepolymer solution P_{B}, and then the butyl acetate was heated and removed under reduced pressure. Next, 2.0 parts by weight of the polyether-modified silicone-caprolactone block copolymer 1 was heated at 80° C. for 2 hours. Next, 0.05 part by weight of zinc stearate was added, to prepare solution B-6. After then mixing 30.3 parts by weight of solution A-6 and 74.3 parts by weight of solution B-6 (hydroxyl equivalent/isocyanate group equivalent ratio: 1.0), the mixture was subjected to reduced-pressure defoaming to obtain a urethane resin composition, which was evaluated.

### Comparative Example 22

As a polyol component, 10.6 parts by weight of (A2) and 0.5 part by weight of 3-isocyanatepropyltriethoxysilane (D4: KBE-9007, trade name of Shin-Etsu Chemical Co., Ltd.) were added to 19.7 parts by weight of (A1), and the mixture was heated and stirred to obtain a homogeneous polyol component solution A-7. Separately, 1.0 part by weight of (A2) was added to 14.4 parts by weight of (B2), and the mixture was reacted at 100° C. for 1 hour under a nitrogen atmosphere to prepare an isocyanate group-remaining prepolymer solution P_{B}. Also, as an isocyanate component, 15.1 parts by weight of (B2), 39.2 parts by weight of (B3) and 0.1 part by weight of the antioxidant were mixed with 15.4 parts by weight of the prepolymer solution P_{B}, and then the butyl acetate was heated and removed under reduced pressure. As a release agent C1, 2.0 parts by weight of isostearic acid and 2.0 parts by weight of a polyester-modified silicone release agent 5 (X-22-715, trade name of Shin-Etsu Chemical Co., Ltd.) were heated at 80° C. for 2 hours. Next, 0.05 part by weight of zinc stearate was added, to prepare solution B-7. After then mixing 30.3 parts by weight of solution A-7 and 74.3 parts by weight of solution B-7 (hydroxyl equivalent/isocyanate group equivalent ratio: 1.0), the mixture was subjected to reduced-pressure defoaming to obtain a urethane resin composition, which was evaluated.

### Comparative Example 23

As a polyol component, 10.6 parts by weight of (A2) was added to 19.7 parts by weight of (A1), and the mixture was heated and stirred to prepare a homogeneous polyol component solution A-8. Separately, 1.0 part by weight of (A2) was added to 14.4 parts by weight of (B1), and the mixture was reacted at 100° C. for 1 hour under a nitrogen atmosphere to prepare an isocyanate group-remaining prepolymer solution P_{B}. Also, as an isocyanate component, 15.1 parts by weight of (B2), 39.2 parts by weight of (B3) and 0.1 part by weight of the antioxidant were mixed with 15.4 parts by weight of the prepolymer solution P_{B}, and then the butyl acetate was heated and removed under reduced pressure. As a release agent C3, 2.0 parts by weight of a montanic acid ester (Licowax-E, trade name of Clariant Japan) and 2.0 parts by weight of polyether-modified silicone-caprolactone block copolymer 1 were heated at 80° C. for 2 hours. Next, 0.05 part by weight of zinc stearate was added, to prepare solution B-8. After then mixing 30.3 parts by weight of solution A-8 and 74.3 parts by weight of solution B-8 (hydroxyl equivalent/isocyanate group equivalent ratio: 1.0), the mixture was subjected to reduced-pressure defoaming to obtain a urethane resin composition, which was evaluated.

[Light Transmittance]

A liquid transfer molding machine was used for molding of a 40 mm×40 mm test piece with a thickness of 1 mm at a mold temperature of 165° C. and a curing time of 20 seconds, and postcuring was carried out at 150° C. for 3 hours. The light transmittance of the obtained test piece was measured at a wavelength of 400 nm using a U-3310 (trade name) spectrophotometer by Hitachi, Ltd. In percentage units, test pieces with a transmittance of 80% or greater were evaluated as satisfactory. The results are shown in Tables 11 and 12.

[Bonding Strength]

A mock-up evaluation of the bonding strength with different members was conducted by forming a cured product on each member and measuring the peel strength. This will now be explained in further detail with reference to FIG. 3. FIG. 3 is a schematic diagram illustrating a method of measuring the shear bonding strength of a cured urethane resin composition. First, a urethane resin composition droplet was dropped onto a silver-plated copper sheet 2 and heated at 165° C. for 3 hours to form a cylindrical cured product 1 with a radius of 1.5 mm. The shear bonding strength of the cured product 1 was measured using a DAYE Series 4000 by Arctec, Inc., with a measuring temperature of 165° C. and a tool travelling speed of 100 μm/s, moving the shear tool 3 in the direction of X. In MPa units, products with strength of 15 MPa or greater were evaluated as (A), and those with less than 15 MPa were evaluated as (B). The results are shown in Tables 11 and 12.

[Detachment after Molding and after Reflow Test]

The detachment between the urethane resin and lead frame in an LED package after molding and after moisture absorption reflow was observed with a microscope. As the moisture absorption reflow test conditions, reflow treatment was conducted under a profile with 9 hours of moisture absorption at 85° C., 85% humidity, followed by 120 seconds at a holding temperature of 150° C., and then 5 seconds at a maximum ultimate temperature of 260° C. The results are shown in Tables 11 and 12. The numerical values of the denominators and numerators for evaluation of the detachment after molding and the detachment after reflow represent, respectively, the total number of evaluation samples and the number of packages with detachment.

[Liquid Transfer Moldability and Releasability]

The molding conditions for liquid transfer molding were a mold temperature of 160-170° C., an injection pressure of 4-15 MPa, an injection time of 15-60 seconds and a retention time of 60-300 seconds. In this molding method, the urethane resin composition was molded into an LED package with outer dimensions of 5.1 mm×3.9 mm×4.7 mm, and the releasability was evaluated at the 10th shot. As the evaluation criteria, sticking of the urethane resin to the cull, runner and cavity sections when the mold was opened, and attachment of the urethane resin to the upper die or lower die was evaluated as (B), and lack of urethane resin sticking, allowing easy removal from the die, was evaluated as (A). The results are shown in Tables 11 and 12.

TABLE 11

| | | | Example | | | |
|---|---|---|---|---|---|---|
| | | | 28 | 29 | 30 | 31 |
| Solution B | Polyether-modified | 1 | 2.0 | — | — | 2.0 |
| | silicone/caprolactone | 2 | — | 2.0 | — | — |
| | block copolymer | 3 | — | — | 1.0 | — |
| | Solution P_{B} | Polyol A2 | 1.0 | 1.0 | 1.0 | — |
| | | Isocyanate B1 | 14.4 | 14.4 | 14.4 | — |
| | Polyisocyanate | Isocyanate B2 | 15.1 | 15.1 | 15.1 | — |
| | component (B) | Isocyanate B3 | 39.2 | 39.2 | 39.2 | — |
| | | Isocyanate B4 | — | — | — | 48.2 |
| | Saturated fatty acid | C1 | 2.0 | — | 1.0 | 2.0 |
| | (C) | C2 | — | 2.0 | — | — |
| | Antioxidant | | 0.10 | 0.10 | 0.10 | — |
| | Curing accelerator | | 0.05 | 0.05 | 0.05 | 0.05 |
| Solution A | Polyol component | Polyol A1 | 19.7 | 19.7 | 19.7 | 51.7 |
| | (A) | Polyol A2 | 10.6 | 10.6 | 10.6 | — |
| | Compound with thiol | Compound with | 0.5 | — | — | 0.5 |
| | group (D) | thiol group D1 | | | | |
| | | Compound with | — | 0.5 | — | — |
| | | thiol group D2 | | | | |
| | | Compound with | — | — | 0.5 | — |
| | | thiol group D3 | | | | |

| | | | | | |
|---|---|---|---|---|---|
| Cured product properties | Light transmittance | 82 | 81 | 81 | 82 |
| | (%) | | | | |
| | Bonding strength | A | A | A | A |
| | Detachment after | 0/15 | 0/15 | 0/15 | 0/15 |
| | molding | | | | |
| | Detachment after | 0/15 | 0/15 | 0/15 | 0/15 |
| | reflow test | | | | |
| | Releasability | A | A | A | A |

TABLE 12

| | | | Comp. Ex. | | | |
|---|---|---|---|---|---|---|
| | | | 20 | 21 | 22 | 23 |
| Solution B | Polyether-modified | 1 | — | 2.0 | — | 2.0 |
| | silicone/caprolactone | 2 | — | — | — | — |
| | block copolymer | 3 | — | — | — | — |
| | | 4 | 2.0 | — | — | — |
| | | 5 | — | — | 2.0 | — |
| | Solution P_{B} | Polyol A2 | 1.0 | 1.0 | 1.0 | 1.0 |
| | | Isocyanate B1 | 14.4 | 14.4 | 14.4 | 14.4 |
| | Polyisocyanate | Isocyanate B2 | 15.1 | 15.1 | 15.1 | 15.1 |
| | component (B) | Isocyanate B3 | 39.2 | 39.2 | 39.2 | 39.2 |
| | | Isocyanate B4 | — | — | — | — |
| | Saturated fatty acid | C1 | 2.0 | — | 2.0 | — |
| | (C) | C2 | — | — | — | — |
| | | C3 | — | — | — | 2.0 |
| | Antioxidant | | 0.10 | 0.10 | 0.10 | 0.10 |
| | Curing accelerator | | 0.05 | 0.05 | 0.05 | 0.05 |
| Solution A | Polyol component | Polyol A1 | 19.7 | 19.7 | 19.7 | 19.7 |
| | (A) | Polyol A2 | 10.6 | 10.6 | 10.6 | 10.6 |
| | Compound with thiol | Compound with | 0.5 | — | — | — |
| | group (D) | thiol group D1 | | | | |
| | | Compound with | — | 0.5 | — | — |
| | | thiol group D2 | | | | |
| | | Compound with | — | — | — | — |
| | | thiol group D3 | | | | |
| | | Compound with | — | — | 0.5 | — |
| | | thiol group D4 | | | | |

| | | | | | |
|---|---|---|---|---|---|
| Cured product properties | Light transmittance | 68 | 31 | 45 | 62 |
| | (%) | | | | |
| | Bonding strength | A | A | A | B |
| | Detachment after | 0/15 | 0/15 | 5/15 | 4/15 |
| | molding | | | | |
| | Detachment after | 0/15 | 0/15 | 5/15 | 6/15 |
| | reflow test | | | | |
| | Releasability | A | B | B | B |

For all of Examples 28-31, cured products were obtained with light transmittance of 80% or greater, and sufficiently excellent adhesion and releasability. The cured product of Comparative Example 20, however, while having no problems of adhesion or releasability, had insufficient optical transparency. Also, the cured products of Comparative Examples 21-23 had insufficient optical transparency and releasability.

### INDUSTRIAL APPLICABILITY

The urethane resin composition of the invention has excellent transparency and releasability, and can exhibit excellent performance as a urethane resin composition to be used for sealing of photosemiconductors.

The cured object of the invention has excellent transparency, releasability from molding dies and adhesiveness with lead frames, and can exhibit excellent performance as a cured object to be used for sealing of photo semiconductors.

The cured object of the invention is also hard with a high glass transition temperature, and excellent homogeneity of transparency, and it can exhibit excellent performance as a cured object to be used for sealing of photosemiconductors.

The urethane resin composition of the invention has excellent transparency, releasability and adhesion, and can exhibit excellent performance as a urethane resin composition to be used for sealing of photosemiconductors.

### EXPLANATION OF SYMBOLS

1: Cured object, 2: silver-plated copper sheet, 3: shear tool, 100: molded resin, 101: opening, 102: semiconductor light emitting element, 103: resin section, 104: sealed body (transparent sealing resin), 105, 106: leads, 107: wire, 108: light extraction surface, 200: surface mount LED package, 302, 302a, 302b: lead frames, 303: bonding member, 304: photosemiconductor element, 305: wire, 306: sealing member, 400: photosemiconductor device.

1. A urethane resin composition comprising:
an aliphatic or alicyclic polyisocyanate;
a saturated polyol; and
zinc stearate with a bulk density of no greater than 0.12 g/ml.

2. The urethane resin composition according to claim 1, wherein the alicyclic polyisocyanate is a bifunctional or trifunctional alicyclic polyisocyanate having an isocyanate group bonded to a secondary carbon atom.

3. The urethane resin composition according to claim 1, wherein the gelling time at 165° C. is no longer than 40 seconds.

4. The urethane resin composition according claim 1, wherein the transmittance of a 1 mm-thick cured object at 589 nm is 90% or greater.

5. A cured object being a cured product of the urethane resin composition according to claim 1.

6. A urethane resin composition obtainable by a method comprising the steps of:
melt mixing an isocyanate (B), an antioxidant (C), a release agent (D) and a dispersing agent (E) to obtain a molten mixture; and
mixing the molten mixture and a polyol (A),
wherein the release agent (D) is a compound represented by the following formula (1):
[Chemical Formula 1]
R¹—COOH (1)
wherein R¹ is a straight-chain or branched C7-28 hydrocarbon group,
the dispersing agent (E) is a compound represented by the following formula (2) having a weight-average molecular weight Mw of no greater than 16000: 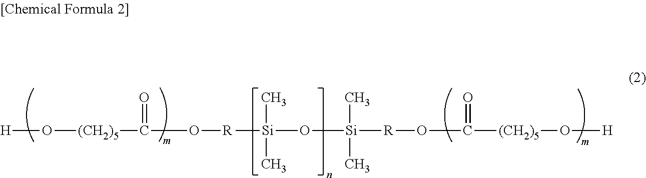
wherein R is a divalent hydrocarbon group, m and n are positive integers, and the ratio of m/n is 0.6 to 0.8, and
the content of the dispersing agent (E) in the urethane resin composition is 0.1 to 5.0 wt %.

7. The urethane resin composition according to claim 6, wherein the content of the release agent (D) in the urethane resin composition is 0.1 to 5.0 wt %.

8. A two-pack type urethane resin composition comprising:
a solution A containing a polyol component; and
a solution B containing a polyisocyanate component,
the two-pack type urethane resin composition including a silane coupling agent with a thiol group in solution A or solution B.

9. The two-pack type urethane resin composition according to claim 8, the polyisocyanate component including:
a bifunctional or trifunctional polyisocyanate of which at least one of the isocyanate groups bonds to a secondary carbon, the polyisocyanate having an alicyclic structure; and
an isocyanate group-remaining prepolymer,
at a total of 30 wt % or greater.

10. The two-pack type urethane resin composition according to claim 8,
wherein the silane coupling agent with a thiol group is γ-mercaptopropyltrimethoxysilane or γ-mercaptopropylmethyldimethoxysilane.

11. The two-pack type urethane resin composition according to claim 8, wherein the content of the silane coupling agent with a thiol group is 0.1 to 2.0 wt % with respect to the total amount of the polyol component and the polyisocyanate component.

12. The two-pack type urethane resin composition according to claim 8, wherein solution B further contains:
a fatty acid represented by the following formula (1); and
a silicone-caprolactone block copolymer represented by the following formula (3) and having a weight-average molecular weight of no greater than 16000,
[Chemical Formula 3]
R¹—COOH (1)
wherein in the formula, R¹ represents a C7-28 straight-chain or branched hydrocarbon group, 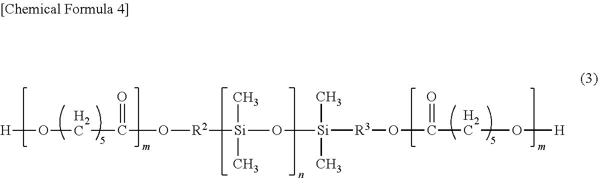
wherein in the formula, m and n are positive integers such that the ratio of m/n is 0.5 to 1.0, R² and R³ each independently represent a divalent hydrocarbon group or a polyether chain.

13. A cured object obtainable by curing a urethane resin composition comprising a polyol component, a polyisocyanate component and a silane coupling agent with a thiol group.

14. The cured object according to claim 13, wherein the urethane resin composition further contains:
a fatty acid represented by the following formula (1); and
a silicone-caprolactone block copolymer represented by the following formula (3) and having a weight-average molecular weight of no greater than 16000,
[Chemical Formula 5]
R¹—COOH (1)
wherein in the formula, R¹ represents a C7-28 straight-chain or branched hydrocarbon group, 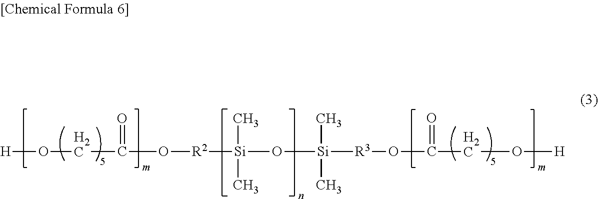
wherein in the formula, m and n are positive integers such that the ratio of m/n is 0.5 to 1.0, R² and R³ each independently represent a divalent hydrocarbon group or a polyether chain.

15. The cured object according to claim 13, wherein the urethane resin composition further contains an inorganic filler.

16. A two-pack type urethane resin composition comprising:
a solution A containing a polyol component; and
a solution B containing a polyisocyanate component,
the two-pack type urethane resin composition including a compound with 2 or more thiol groups in solution A or solution B.

17. The two-pack type urethane resin composition according to claim 16, the polyisocyanate component including:
a bifunctional or trifunctional polyisocyanate of which at least one of the isocyanate groups bonds to a secondary carbon, the polyisocyanate having an alicyclic structure; and
an isocyanate group-remaining prepolymer,
at a total of 30 wt % or greater.

18. The two-pack type urethane resin composition according to claim 16, wherein the compound with 2 or more thiol groups further has a sulfide group.

19. The two-pack type urethane resin composition according to claim 18, wherein the compound with 2 or more thiol groups is 2,2′-dimercaptodiethyl sulfide.

20. The two-pack type urethane resin composition according to claim 16, wherein the content of the compound with 2 or more thiol groups is 0.01 to 2.0 wt % with respect to the total amount of the polyol component and the polyisocyanate component.

21. The two-pack type urethane resin composition according to claim 16, wherein solution A or solution B further contains:
a saturated fatty acid represented by the following formula (1); and
a silicone-caprolactone block copolymer represented by the following formula (3) and having a weight-average molecular weight of no greater than 16000,
[Chemical Formula 7]
R¹—COOH (1)
wherein in the formula, R¹ represents a C7-28 straight-chain or branched saturated hydrocarbon group, 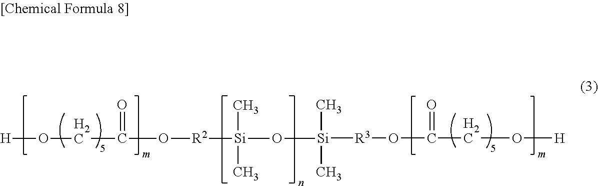
wherein in the formula, m and n are positive integers such that the ratio of m/n is 0.5 to 1.0, R² and R³ each independently represent a divalent hydrocarbon group or a polyether chain.

22. A cured object obtainable by curing a urethane resin composition comprising:
a polyol component;
a polyisocyanate component; and
a compound with 2 or more thiol groups.

23. The cured object according to claim 22, wherein the urethane resin composition further contains:
a saturated fatty acid represented by the following formula (1); and
a silicone-caprolactone block copolymer represented by the following formula (3) and having a weight-average molecular weight of no greater than 16000,
[Chemical Formula 9]
R¹—COOH (1)
wherein in the formula, R¹ represents a C7-28 straight-chain or branched saturated hydrocarbon group, 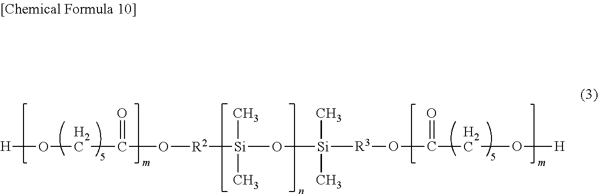
wherein in the formula, m and n are positive integers such that the ratio of m/n is 0.5 to 1.0, R² and R³ each independently represent a divalent hydrocarbon group or a polyether chain.

24. The cured object according to claim 22, wherein the urethane resin composition further contains an inorganic filler.

25. A urethane resin composition comprising:
solution A containing a polyol component; and
solution B containing a polyisocyanate component,
wherein the polyol component includes a trifunctional or greater polyol compound having a hydroxyl value of 600 mgKOH/g or more and 1300 mgKOH/g or less, and having a molecular weight of no greater than 400.

26. The urethane resin composition according to claim 25, wherein the polyisocyanate component comprises at least 30 wt % of an alicyclic polyisocyanate compound having an alicyclic group and 2 or 3 isocyanate groups, with at least one of the isocyanate groups bonded to a secondary carbon composing the alicyclic group.

27. The urethane resin composition according to claim 25, wherein the polyol compound is a compound in which propylene oxide, ethylene oxide or caprolactone is added to trimethylolpropane or propane-1,2,3-triol.

28. The urethane resin composition according to claim 27, wherein the polyol compound is a compound in which propylene oxide is added at 1-2 mol to 1 mol of trimethylolpropane.

29. The urethane resin composition according to claim 25, wherein the content of the polyol compound is 80 wt % or greater with respect to the total weight of the polyol component.

30. The urethane resin composition according to claim 25, wherein solution A or solution B:
includes a saturated fatty acid represented by the following formula (1), or
includes the saturated fatty acid and a silicone-caprolactone block polymer represented by the following formula (3) and having a weight-average molecular weight of no greater than 16000,
[Chemical Formula 11]
R¹—COOH (1)
wherein in the formula, R¹ represents a C7-28 straight-chain or branched saturated hydrocarbon group, 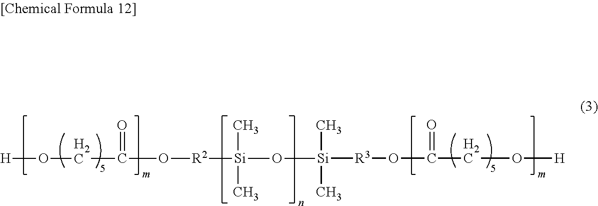
wherein in the formula, m and n represent positive integers such that m/n is 0.5 to 1.0, R² and R³ each independently represent a divalent hydrocarbon group or a polyether chain.

31. A cured object obtainable by curing a urethane resin composition comprising:
solution A containing a polyol component including a trifunctional or greater polyol compound having a hydroxyl value of 600 mgKOH/g or more and 1300 mgKOH/g or less and having a molecular weight of no greater than 400; and
solution B containing a polyisocyanate component,
by mixing solution A and solution B.

32. The cured object according to claim 31, wherein solution A or solution B:
includes a saturated fatty acid represented by the following formula (1), or
includes the saturated fatty acid and a silicone-caprolactone block polymer represented by the following formula (3) and having a weight-average molecular weight of no greater than 16000,
[Chemical Formula 13]
R¹—COOH (1)
wherein in the formula, R¹ represents a C7-28 straight-chain or branched saturated hydrocarbon group, 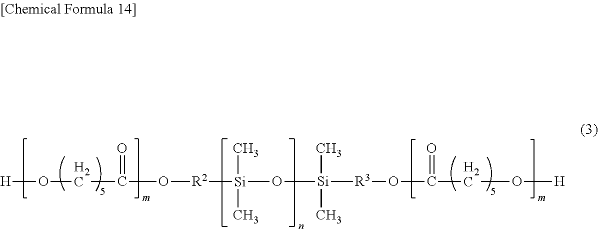
wherein in the formula, m and n represent positive integers such that min is 0.5 to 1.0, R² and R³ each independently represent a divalent hydrocarbon group or a polyether chain.

33. The cured object according to claim 31, wherein solution A and/or solution B further contains an inorganic filler.

34. A urethane resin composition comprising:
(A) a polyol component; and
(B) a polyisocyanate component,
wherein the polyisocyanate component is an isocyanate component comprising an alicyclic polyisocyanate compound having an alicyclic group and 2 or 3 isocyanate groups, at least one of the isocyanate groups being bonded to a secondary carbon composing the alicyclic group, at 30 wt % or greater of the total isocyanate component, and
the urethane resin composition further comprises:
a polyether-modified silicone-caprolactone block copolymer represented by the following formula (4): 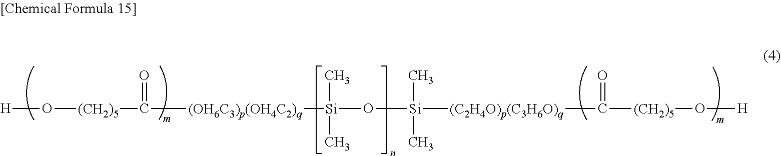
wherein m and n represents positive integers such that m/n is 0.5 to 1.0, and p and q represents positive integers such that p and q>1, and p or q>2; and
(C) a saturated fatty acid represented by the following formula (1):
[Chemical Formula 16]
R¹—COOH (1)
wherein R¹ represents a C7-28 straight-chain or branched hydrocarbon group.

35. The urethane resin composition according to claim 34, further comprising (D) a compound with a thiol group.

36. The urethane resin composition according to claim 35, wherein the compound with a thiol group is a compound with 2 or more thiol groups, or a silane coupling agent with a thiol group.

37. A photosemiconductor device provided with a sealing member comprising a cured object obtainable by curing the urethane resin composition according to claim 6.

38. A photosemiconductor device provided with a sealing member comprising a cured object obtainable by curing a urethane resin composition according to claim 34.

39. A photosemiconductor device provided with a sealing member comprising a cured object according to claim 13.

40. A photosemiconductor device provided with a sealing member comprising a cured object according claim 22.

41. A photosemiconductor device provided with a sealing member comprising a cured object according to claim 31.
